(19) United States
(12) Patent Application Publication
(10) Pub. No.: US 2020/0252780 A1
(43) Pub. Date: Aug. 6, 2020

(54) EMERGENCY ALERT USER SYSTEM AND METHOD

(71) Applicant: AC&C, LLC, Baton Rouge, LA (US)

(72) Inventors: W. Hutchinson McClendon, IV, Ethel, LA (US); Darren M. Vallaire, Baton Rouge, LA (US); John Anderson, Baton Rouge, LA (US)

(73) Assignee: ADVANCED COMPUTER AND COMMUNICATIONS, L.L.C., Baton Rouge, LA (US)

(21) Appl. No.: 16/610,489

(22) PCT Filed: May 1, 2018
(86) PCT No.: PCT/US18/30452

§ 371 Date: Nov. 1, 2019

Related U.S. Application Data
(60) Provisional application No. 62/500,487, filed on May 2, 2017.
(60) Provisional application No. 62/630,921, filed on Feb. 15, 2018.

(51) Int. Cl. H04W 4/90; H04W 4/021

(52) U.S. Cl. CPC H04W 4/90; H04W 4/021

(57) ABSTRACT

An alert system and method can validate an operator that is sending a targeted alert message. A notification server can receive an emergency message from a client device. The emergency message can include a primary emergency alert and a specification of a geographic area of concern. The notification server can be configured to determine whether the emergency message is valid. A transmission system can be configured to, upon validation of the emergency message, transmit the emergency message to an alert-enabled device. The alert-enabled device can be configured to receive the emergency message, to determine if the alert-enabled device is within the geographic area of concern, and to present the emergency message to a user if and only if the alert-enabled device is located within the geographic area of concern.

### PRIORITY CLAIM

This application claims priority to U.S. Provisional Patent Application No. 62/500,487, filed May 2, 2017 and U.S. Provisional Patent Application No. 62/630,921, filed Feb. 15, 2018, each of which is incorporated by reference in its entirety.

### FIELD OF THE INVENTION

This invention relates in general to a system and method permitting a user to communicate via emergency alert messages to specified members of the public.

### BACKGROUND

Emergency alert systems are widely used. One common example of such a system is the emergency broadcast system used on television and radio. This system is often used to transmit information about potentially dangerous weather conditions. Other emergency alert systems rely on land-based telephone systems to send recorded messages to all persons within a particular area. Evacuation orders are another form of an emergency alert message, and these orders can rely on telephone systems, door-to-door communication by public safety officers, and other emergency communication methods.

The mass notification industry is currently a $1.7 B industry for North America and expected to grow by approximately 18% over the next five years. A driver of this growth is governmental agencies that are engaged in public safety initiatives. These agencies typically pay venders for alert systems.

As further discussed herein, previous systems suffer many drawbacks. Accordingly, a goal of the inventions claimed, and as described through various embodiments, is to address the shortcomings and drawbacks of those previous systems.

### SUMMARY

In one aspect, an alert system can include a notification server that receives and validates an emergency message from a client device the message including a primary emergency alert message and a geographic area message representative of at least part of a geographic area of concern; and a transmission system that sends the validated emergency message to an alert enabled device configured to receive the alert message and geographic area message and to present the alert message to a user if and only if the alert enabled device is located within the geographic area of concern as determined by the alert enabled device.

In another aspect, a method of validating a geographically targeted alert message can include selecting or creating an alert message; validating the alert message by confirming authorization of an operator by geographic area; and transmitting validated alert message and geographic area message to an alert enabled device.

The present invention provides emergency alert system. The invention also provides a method of sending geographically-targeted alert messages to alert enabled devices. Only those alert devices within the geographic area at risk are notified of the emergency. The alert devices are small devices that can be embedded within host devices such as cell phones, automobile stereos and/or navigation systems, televisions, radios, computers, MP3 players, land-line telephones, and virtually any other host device with the capacity to communicate message content to an end user. By incorporating the alert devices into a wide variety of hosts, the present invention creates an alert device with the potential to reach virtually all appropriate persons very quickly. It is reliable, easy to operate, fast, and is geographically selective. It also requires only routine upkeep.

In an embodiment, the invention includes an operations center that selects an alert message, creates a geographic area message that is representative of the geographic area of concern, and transmits the alert message and geographic area message; and, an alert enabled device that receives the alert message and geographic area message and that presents the emergency alert message if and only if the alert enabled device is located within the geographic area of concern.

In some embodiments, the invention can further include a channel. In some embodiments, the invention can further include a plurality of channels. The alert message can be delivered using a series of broadcasts over the channel and/or the plurality of channels. The alert message can be processed by the device as a single or multiple data packets.

In an aspect, an alert system can have an operations center and an alert enabled device. The operations center can be capable of selecting and/or creating a primary emergency alert message, creating a geographic area message, and transmitting the alert message and/or the geographic area message. The geographic area message can be representative of at least part of a geographic area of concern. The alert enabled device can be configured to receive the alert message and/or geographic area message and/or configured to present the alert message to a user if or only if the alert enabled device is located within the geographic area of concern, which can be determined by the alert enabled device.

In an embodiment, the alert enabled device can retain prior GPS location data, for example during periods in which accurate, real-time GPS data is not available. The device can use the most recent, accurate GPS location data, for example, to determine whether the device is within a geographic area of concern. The alert enabled device can be configured to check stored geographic area messages when the alert enabled device is moving to determine whether the alert enabled device has moved into an active geographic area of concern. In some embodiments, the alert enabled device can determines whether to present the alert message based on, e.g., location information received from a device in communicative proximity to the alert enabled device.

In other embodiments, the alert enabled device can be embedded in a host device and can be configured to turn on the host device if necessary to present an alert message. The alert enabled device can be configured to turn off the host device after such alert message has been presented.

In yet other embodiments, the alert enabled device can be embedded in a host device and can be configured to change the host device operating mode to a mode required for receipt of an alert message. The alert enabled device can be configured to return the host device to its prior operating mode after such alert message has been presented.

In some embodiments, the alert enabled device can be embedded in a GPS enabled cellular phone, which can be capable of receiving wireless Internet signals. The alert enabled device can alternatively be embedded in a GPS enabled portable computer, which can be capable of receiving wired or wireless Internet signals.

In other embodiments, the operations center can be capable of sending messages via the Internet. The alert message can be a commercial message intended to reach a particular audience.

In another aspect, an alert system can have an alert message, a geographic area message, a unique identifier, and an alert enabled device. The geographic area message can be representative of a geographic area of concern for the alert message. The unique identifier can be assigned to the alert message, the geographic area message, or both messages. The alert enabled device can receive the alert message and/or the geographic area message. The alert enabled device can present the alert message and can be configured to present the message if and only if the alert enabled device is located within the geographic area of concern, which can be determined by the alert enabled device. In some embodiments, the alert enabled device can determines whether to present the alert message based on, e.g., location information received from a device in communicative proximity to the alert enabled device.

In some embodiments, the alert message and geographic area message can be combined into a unitary message. A unique identifier can be assigned to the combined, unitary message. The unique identifier can further have a unique serial number. A unique identifier can be used by the alert enabled device to distinguish between different messages.

In other embodiments, the unique identifier can be associated with a distinct group of persons, for example, such that the alert message can be directed to the members of the group who are located within a geographic area of concern. The alert enabled device can be configured to recognize when a received unique identifier is associated with the user or one or more users.

In yet other embodiments, an alert message can be a commercial message intended to reach a particular audience. The user can program the alert enabled device to receive or not receive certain commercial messages. The user's ability to receive commercial messages can be disabled, for example, if the alert enabled device detects movement consistent with travel, such as by automobile.

In an aspect, a method of communicating a geographically targeted alert message can include the steps of selecting and/or creating an alert message, creating a geographic area message, transmitting the alert message and the geographic area message, receiving the alert message and/or geographic area message by an alert enabled device, processing the geographic area message, and presenting the alert message to a user. The geographic area message can be representative of a geographic area of concern. The geographic area of concern can be based, in whole or in part, on factors taken from, for example, the nature of the alert, the severity of the threat posed by the alert, weather conditions, geographic jurisdiction of the authority issuing the alert message, population, evacuation routes, and/or topography. Processing the geographic area message can include determining whether the alert enabled device is located within a geographic area of concern. The alert message to a user can be presented if or only if the emergency alert enabled device is located within a geographic area of concern.

In an embodiment, the method can further include directing a user to evacuate a geographic area of concern. The alert enabled device can present a warning to the user if the alert enabled device remains within the geographic area of concern after a preselected period of time, for example, such time period allowing sufficient time for the user to evacuate the geographic area of concern. The method can further, or alternatively, include evaluating traffic conditions along evacuation routes and/or presenting users with directions to take alternate routes, for example, in the event primary evacuation routes are overly congested with traffic.

In another embodiment, the method can include determining if an alert enabled device is within an airplane in flight. If the alert enabled device is within an airplane in flight, the method can include blocking presentation of alert messages intended for persons on the ground.

In an aspect, a method of communicating a geographically targeted alert message can include selecting and/or creating an alert message, creating a geographic area message, assigning a unique identifier to the alert message, the geographic area message, or both messages, transmitting the alert message and/or geographic area message, receiving the alert message and/or geographic area message by an alert enabled device, processing the geographic area message, and presenting the alert message to a user. The geographic area message can be representative of a geographic area of concern. The geographic area message can be processed, for example, to determine whether the alert enabled device is located within a geographic area of concern. The alert message can be presented to a user based on a condition, for example if and only if the alert enabled device is located within the geographic area of concern.

In an embodiment, the unique identifier can be associated with a distinct group of persons. The alert message can be directed to members of the group such that only those who are located within the geographic area of concern receive or are presented with the alert message. The alert enabled device can be configured to recognize when a received unique identifier is associated with a particular user of the alert enabled device or a particular alert enabled device.

In some embodiments, the alert message can be presented if and only if the device contains pre-selected medical, commercial and/or corporate information. Additionally or alternatively, an alert message can be presented if and only if the device receives the message within a pre-determined time. In an embodiment, an alert message can be presented in multiple languages and/or in one or more preselected languages.

In another aspect, a method of targeting communications can include transmitting a message and a set of diagnostic queries. An alert-enabled device can receive the message and the set of diagnostic queries. The alert-enabled device can determine answers to the diagnostic queries based on information stored in the alert-enabled device, and can, based on the answers, determine whether to display the message on the alert-enabled device.

Other aspects, embodiments, and features will be apparent from the following description, the drawings, and the claims.

### BRIEF DESCRIPTION OF THE DRAWINGS

The accompanying drawings illustrate preferred embodiments of this invention. However, it is to be understood that these embodiments are not intended to be exhaustive, nor limiting of the invention. These embodiments are but examples of some of the forms in which the invention can be practiced.

FIG. 1 is a graphical representation of the present invention.

FIG. 2 is a graphical representation of certain steps of an embodiment of the invention.

FIG. 3 is a graphical representation of additional steps of an embodiment of the invention.

FIG. 4 is a flow chart showing an embodiment of the present invention.

FIG. 5 is a block diagram of another embodiment of the present invention.

FIG. 6 is a flow chart for one embodiment of an EAED.

FIG. 7A is a flow chart for a second embodiment of an EAED FIG. 7B is a flow chart for a second embodiment of an EAED.

FIG. 8 is a block diagram of an electronic device in accordance with aspects of the invention.

FIG. 9A is a front view of an embodiment of the electronic device of FIG. 8 in accordance with aspects of the invention. FIG. 9B is a front view of an embodiment of the electronic device of FIG. 8 in accordance with aspects of the invention.

FIG. 10 is a front view of an embodiment of the electronic device of FIG. 8 in accordance with aspects of the invention.

FIG. 11 is an exemplary emergency alert message created by an emergency operator shown in FIG. 11.

FIG. 12A an exemplary emergency alert presented on the electronic device. FIG. 12B an exemplary emergency alert presented on the handheld device.

FIG. 13A is an exemplary emergency alert message that may be presented on the electronic device. FIG. 13B is an exemplary emergency alert message that may be presented on the handheld device.

FIG. 14 is an exemplary depiction of embodiments of the present invention.

FIG. 15 is an exemplary depiction of a process for registering operators.

FIG. 16 is an exemplary depiction of a process for managing a message from an operator of the notification system.

FIG. 17 is an exemplary depiction of process for validating a message.

FIG. 18 is an exemplary illustration of certain components of a mass notification network ecosystem of the present invention.

FIG. 19 is an exemplary diagram illustrating certain functions of a clearinghouse embodiment of the present invention.

FIG. 20 is an exemplary overview of a clearinghouse set up according to an embodiment of the present invention.

FIG. 21 is an exemplary flow diagram for a mass notification network of the present invention.

### DETAILED DESCRIPTION

As the public has become more concerned about terrorism threats and as communication systems have become more pervasive, a need has arisen for a better emergency alert system. Existing technologies suffer from many problems. A door-to-door communication of emergency information is effective at targeting only persons actually located in the area deemed to be at risk. Though door-to-door communication can be slow—the speed of this method depends on the number of persons to be contacted and the number of persons going door-to-door—it does provide the emergency information to the relevant members of the public. This benefit, however, comes at a very high price. Dedicating many law enforcement officers' time to going door-to-door costs a great deal of money and creates troublesome opportunity costs. If three-fourths of the local police force is going door-to-door to warn persons about an emergency situation, those officers cannot be patrolling for crimes or other problem situations. Though it is one means of geographically disseminating an emergency alert, door-to-door emergency communication is typically seen as a means of last resort.

Sirens also have been used to alert persons to emergencies. A siren system is perhaps most effective for a particular purpose. A chemical plant, for example, might use sirens to warn persons near the plant of a problem. Sirens have limited range and require regular upkeep. Sirens typically do not provide situation-specific information. Persons inside houses or in automobiles may not hear sirens even when they are relatively near the siren. The one upside to sirens is their partial geographic selectivity. Only persons within a certain radius of the siren will get the alert. Even this advantage is limited, however, because in most emergencies, the alert area will not be a perfect circle around a particular siren. For these reasons, sirens remain a generally poor means of alerting persons of an emergency.

The emergency broadcasting system (EBS) sends emergency alert messages via live television and radio feeds. Though this system can reach many persons quickly, its reach is both too broad and too narrow. It is too broad because an entire television and radio broadcast region will be covered when most emergency alerts are relevant to only some part of that region. It is too narrow because even persons who are using their televisions or stereos may not be receiving a live television or radio transmission. Television viewers may be watching a movie on DVD, watching a pre-recorded television program, or viewing a satellite television broadcast. Persons listening to stereos may be listening to satellite radio or a music CD. None of these persons would receive the EBS alert.

Automated telephone calling systems are widely used for sending emergency alert messages. This system is geographically specific, because only those phones within a defined alert area will be called. There are, however, several problems with these systems. They are expensive to purchase and use. They do not reach nearly all the relevant public. Many persons miss phone calls, and most of these systems call only landline phones. That excludes all cell phones and VOIP phones. Because some numbers must be called many times to reach a person, this process also can be slow. Finally, when a telephone alert system is used, it can jam the local telephone switching network, thus slowing the system and making it very difficult for local persons to use their own phones.

Internet and e-mail also can be used to send emergency alert information. This process can work quickly, but it has limited reach. It is also not geographically limited.

Given the heightened concerns with emergency threats and the many flaws in existing emergency alert systems, there exists a need for a better system. Such a system should operate quickly and reach all persons within the appropriate geographic area. It should be affordable to own and operate. A cost-effective geographically targeted emergency alert system is needed.

Some geographic targeting has been attempted in the area of emergency alerts and other geographically targeted alerts. For example, the widely-used cellular telephone system has been used to provide a certain type of geographically targeted messaging. Cellular transmissions are relatively short-range transmissions, and therefore many cell towers are required throughout a geographic region to ensure continuous or nearly continuous coverage. When a particular cell tower transmits a message, that message will reach a limited geographic area.

If a cell tower transmits omni-directionally, the geographic area reached by the transmission will be generally circular. Those cell phone users with the right type of phone and who are located within the broadcast range of the transmitting tower will receive the message. More recently, technologies have been developed to allow cell towers to transmit somewhat directionally, which produces a pie or wedge-shaped coverage area.

Some cell systems also geographically target cell users based on the residence area of the user. This approach fixes a particular location or area for a user based on where the user lives or works. Other alert systems have used a similar approach in the past. For example, some tornado warning systems alert users based on a pre-determined, fixed location for the user. All systems of this type suffer from one major problem: they are used pre-determined, fixed location information for users who are highly mobile. These systems are not dynamic. They cannot account for movement of persons.

This reliance on fixed location data is a major drawback, because the system will miss in two important ways. First, this type of system will fail to alert visitors to the area of pending emergencies. A person who is visiting an area when a tornado strikes would not receive a warning with this type of system. Second, this type of alert system will warn residents who are not within the alert area. A person who resides in the warning area, but who is away at the time of the warning, will receive the alert. These two problems greatly reduce the efficacy of these types of warning systems.

The cellular tower location systems, using either omni-directional or semi-directional transmissions provide one means of resolving these problems. Only users who are physically within a geographic area will get the alerts. To achieve this result, however, the systems must limit the alert transmissions to rather crudely-defined geographic areas. Persons currently outside the broadcast area, but who are traveling toward the area, will receive no alert until within the broadcast area. Moreover, if the actual emergency is more localized than the cellular transmission area, this type of system will present the alert to persons outside the danger area.

Though the cellular transmission systems provide improvement over systems that rely on pre-determined, fixed user location data, the improvement is limited. To appreciate why, one must understand the two basic approaches to this problem. One approach is to consider the problem from the perspective of the alert transmission. This approach can be thought of as a “front-end” approach. The second approach is to consider the problem from the perspective of the users, the persons or businesses in a geographic area facing some risk. This approach can be thought of as a “back-end” approach.

All the systems described above are front-end systems. None of these systems rely on discrimination or decision at the user end. The geographic targeting all comes from the transmission end. The cellular tower systems are a good example. These systems are directional, but only in a front-end sense. All discrimination (i.e., all decisions concerning who gets an alert) is done at the front-end.

What is needed is a back-end solution to this problem, and one that allows for dynamic location fixes for users. An example of a crude back-end system would be one in which a message is broadcast to a large audience, and the members of the audience are to make their own determinations of whether the message is relevant to them. One simple example might be a PA announcement at a large sporting event (e.g., a football game) asking the person with the red convertible to move it from in front of the ticket office. The message of broadcasts to a large audience, and the members of that audience perform the discrimination steps of the process. Presumably, only the person (or persons) who parked a red convertible in front of the ticket office will respond to the message.

This general concept (i.e. back-end discrimination) has not been used in emergency alert systems. Perhaps this is because of a concern that widespread dissemination of targeted alert messages could induce hysteria. Or perhaps it is because those responsible for sending emergency messages tend to work at front-end facilities and have only considered the problem from that perspective. But whatever the reason for this focus, there has been a lack of attention on back-end type alert systems. There is, therefore, a real need for an improved, dynamic alert system that relies on back-end discrimination. Such a system would allow for relatively large area broadcasts of alert messages, potentially advising persons who are outside the alert area but approaching it. Such a system would also allow for precise area definition, or precise target audience definition (e.g., only firefighters or EMTs). It would not rely, however, on the individual user to perform the discrimination process (as in the football game example), but would use a technological solution. This new technology would perform the discrimination and then alert the user, if and only if, the user is within the relevant geographic area and/or is within the relevant target audience.

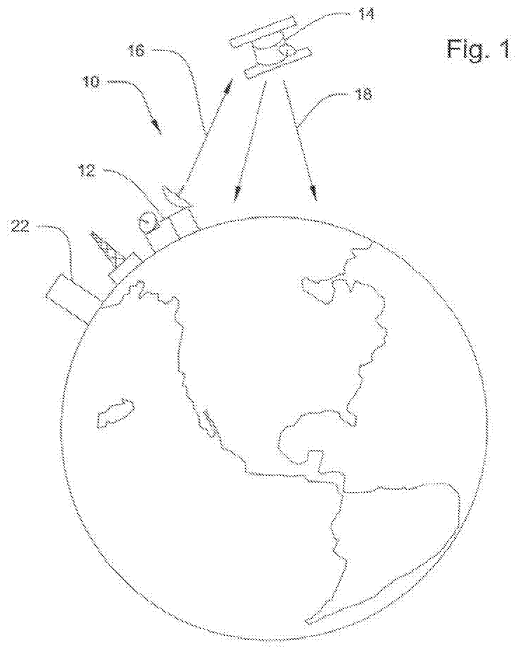

Key elements of an emergency alert system (EAS) 10 are shown generally in FIG. 1. An emergency alert transmission center 12 receives an emergency alert message and geographic data from an emergency operations center (EOC) 22, and transmits one or more signals 16 to an emergency system satellite 14. The signals 16 correspond to a geographic area message, which is based on a geographic area of concern, and an emergency alert message, which is intended for persons located within the geographic area of concern. The EOC 22 and the emergency alert transmission center 12 could be a single facility or could be separate facilities. In a preferred embodiment, the emergency alert transmission center 12 is a separate facility and serves a number of EOCs 22 from different geographic areas. For example, a single emergency alert transmission center 12 would be capable of serving EOCs 22 from numerous states, cities, or other areas. The emergency alert transmission center has one or more transmitters for sending the required messages to emergency system satellites 14.

Key elements of an EAS 10 are shown generally in FIG. 1. An emergency alert transmission center 12 receives an emergency alert message and geographic data from an emergency operations center (EOC) 22, and transmits one or more signals 16 to an emergency system satellite 14. The signals 16 correspond to a geographic area message, which is based on a geographic area of concern, and an emergency alert message, which is intended for persons located within the geographic area of concern. The signals 16 can also include additional information such as time and date information, medical information and corporate information such as work schedules, instructions, etc. The EOC 22 and the emergency alert transmission center 12 could be a single facility or could be separate facilities. In a preferred embodiment, the emergency alert transmission center 12 is a separate facility and serves a number of EOCs 22 from different geographic areas. For example, a single emergency alert transmission center 12 would be capable of serving EOCs 22 from numerous states, cities, or other areas. The emergency alert transmission center has one or more transmitters for sending the required messages to emergency system satellites 14.

Though the invention is shown using a satellite 14 for the retransmission of the emergency alert message and geographic area message to earth, other means of transmitting these messages can be used. The cellular system provides the capability to transmit to nearly all of the geographic area of the United States and many other developed countries of the world. The emergency alert transmission center 12 can send emergency alert messages and geographic area messages via cellular transmissions, either as an alternative, or in addition to, satellite transmissions. The use of satellite transmissions is preferred because such systems are capable of targeting the entire globe and do not suffer from certain catastrophes, such as a power grid failure. But the invention is not limited in this regard, and practical or economic concerns can make other systems preferable, such as cellular-based systems or wireless connectivity provided by high-altitude balloons.

The Internet provides an example of an alternative transmission means. The emergency alert and geographic area messages could be transmitted via the Internet to devices capable of receiving both Internet signals and GPS signals. In this embodiment, the alert device would receive the emergency message and the geographic area message via the Internet and then compare the geographic area message to the GPS location data for the device in real time. If the GPS data indicates that the device is located within the geographic area of concern, the emergency message would be transmitted. This embodiment can be of particular utility for persons with GPS enabled cellular phones that also have the capability to receive wireless Internet signals. Such phones are becoming increasingly common, making this embodiment a more viable alternative to the system that uses satellite transmissions for all messages and data. It should also be appreciated by those of skill in the art that GPS location data could be replaced with location data from cellular towers, routers, and other wireless connectivity systems.

Additional examples an alternative transmission means include, but are not limited to, a Wireless Mesh Network (WMN) and Wi-Fi Direct. Both WMN and Wi-Fi Direct can be particularly useful during a power outage that precludes devices from receiving messages over the cellular network or Internet. Wi-Fi Direct is a Wi-Fi standard that enables device to device messaging, which permits devices to connect easily with each other without utilizing a wireless access point. A WMN is a communications network made up of radio nodes organized in a mesh topology. Wireless mesh networks can comprises mesh clients, mesh routers and gateways. The mesh clients are often laptops, cell phones and other wireless devices while the mesh routers forward traffic to and from the gateways which may, but need not, connect to the Internet. The coverage area of the radio nodes working as a single network is sometimes called a “mesh cloud.” Access to this “mesh cloud” is dependent on the radio nodes working in harmony with each other to create a radio network. A mesh network is reliable and offers redundancy. When one node can no longer operate, the rest of the nodes can still communicate with each other, directly or through one or more intermediate nodes. Wireless mesh networks can be implemented with various wireless technology including 802.11, 802.15, 802.16, cellular technologies or combinations of more than one type. By sending a message combined with the geographic coordinates and other filtering criteria (e.g. date and time, medical information, corporate information, etc.) to a device in the WMN, the message can then be transmitted throughout the “mesh cloud.” Once the message is received by the alert device, the device determines if the message should be displayed using the filtering criteria that can be stored on the device.

The invention can be used with a single emergency alert transmission center 12 that handles all the satellite transmission tasks for several EOCs 22. There are existing EOCs located throughout the world. Most regional governmental bodies (e.g., state, county or parish, and city governments) operate such EOCs. Some of these EOCs have satellite transmission capabilities and some do not. By routing all the EAS messages through a dedicated emergency alert transmission center 12, a substantial cost-savings can be passed on to the tax-paying public. In addition, using a dedicated emergency alert transmission center 12 can improve the efficacy of the system by ensuring that no conflicting messages are sent by different EOCs 22. On the other hand, it can be more desirable to have multiple EOCs with the capability to use the current invention independently of each other, with each EOC communicating directly with the appropriate satellites or other transmission system. This embodiment of the invention would distribute the potential failure points, thus reducing the risk of a single point of failure disabling the system. Which embodiment ultimately is preferred may depend upon the circumstances at the time the system is implemented.

The emergency system satellite 14 retransmits one or more signals 18 back to the earth, where these transmissions are received by emergency alert enabled devices (EAEDs) 20. As described above, these signals 18 correspond to a geographic area message and an emergency alert message. The EAEDs are not shown in FIG. 1, but will be discussed in more detail below.

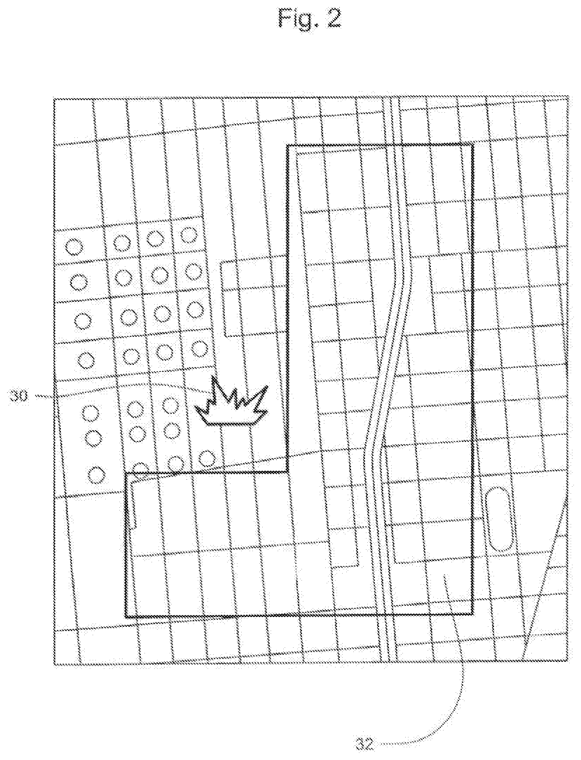

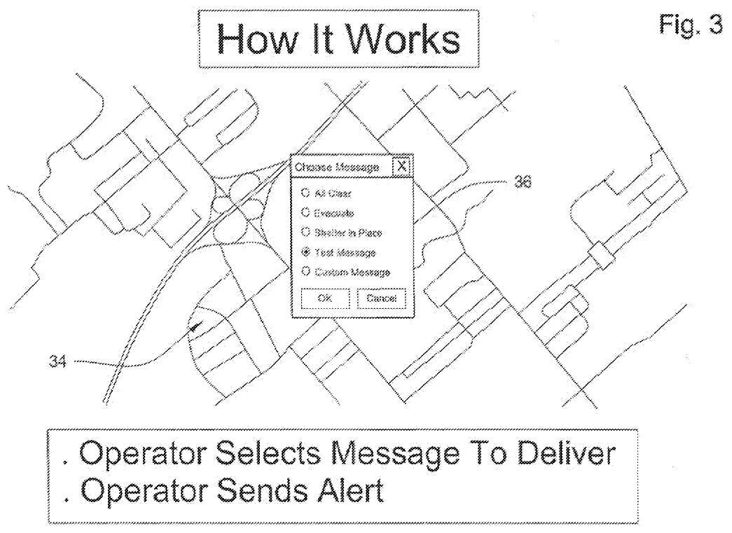

FIGS. 2 and 3 show steps of a preferred embodiment of the invention. FIG. 2 is an overhead representation of an illustrative geographic region. An emergency situation has occurred at a site 30, and personnel at an EOC 22 (not shown in FIG. 2) have decided that an emergency alert message should be communicated to all persons within a particular geographic area of concern 32, which is shown in blocked off form in FIG. 2. The geographic area of concern 32 could be circular, semi-circular, rectangular, or take any other shape, including a freehand drawing. Handles or other common tools can be used by operators to easily expand or contract all or parts of a defined geographic area. Operators at the EOC must make a determination of what geographic area 32 should be notified of the emergency.

In the hypothetical illustration shown in FIG. 2, a fire has occurred at a chemical facility, posing a risk of hazardous airborne materials in an area nearby and downwind of the fire location. Operators at the EOC are informed of the emergency and the risk. The operators then determine an appropriate geographic area 32 within which all persons must receive the alert message. The system thus creates and transmits geographically targeted emergency alert messages. Only those persons within the relevant geographic area are targeted for message transmission. Using the present invention, an operator might use geographic mapping software to define an alert area. This process could use electronic street maps, satellite images, or combined satellite images overlaid with street map information. The operator might also select from a list of pre-defined geographic areas (e.g., county or parish, state, etc.) to define an alert area. The system can transmit the geographically targeted emergency alert messages at any time (e.g., immediately, after a pre-determined or selected time interval, at a predetermined time interval until canceled, at a predetermined time interval for a pre-determined number of times or until a specified expiration time, and so forth).

Though the invention can use electronic maps, the present invention is not dependent upon maps or the mapping process. The invention can use actual latitude and longitude coordinates to define the area of concern and to establish the exact location of a particular user. This approach provides accurate and reliable position information. Maps can be out dated or otherwise inaccurate. In addition, persons can be in an uninhabited area on a map (e.g. on a lake or in a forest), but the present invention can still be able to reach those persons if they are located within the area of concern for the emergency. Most prior art systems rely, to some extent, on maps, either hard-copy or electronic, and are, therefore, inferior to the present invention in this regard.

A computer or equivalent device can be used to generate a geographic area message. This message would include an electronic representation (e.g., in the form of an algorithm) of the geographic area of concern for the particular emergency. The geographic area 32 shown in FIG. 2 is an illustration of a geographic area of concern. A geographic area message might include a series of mathematical expressions that define the geographic area 32 in such a manner that a processor in an EAED 20 can use the expressions to determine whether the actual geographic location of the EAED 20 is within the area of concern.

In this example, an EOC operator defined an alert area south and east of the fire. This is shown by the geographic area 32 in FIG. 2. Data representative of this geographic area is prepared for transmission to the emergency alert transmission center 12. The processing of the geographic area data can be done in various ways that are known to persons skilled in the art.

The invention can also include other enhancements or features at the EOC stage. For example, the EOC part of the system could limit operators' access to only those geographic regions within the jurisdiction of the entity operating the EOC. Or the system could send a message directly to other EOCs for geographic regions that are within the area of concern, but outside the originating EOC's jurisdiction. These features could be implemented in a seamless manner, and could occur automatically when an operator defines an area of concern that extends beyond the EOC's jurisdiction.

The maps used by EOC operators can provide certain detailed information to aid the operators in quickly and accurately identifying an area of concern. Topographical features, such as mountains, might be relevant for this purpose. Prevailing wind patterns can also be provided, as well as evacuation routes, population figures, and other data that can impact the decision of how to define a geographic area of concern. The system also can provide the operator with the physical size of the defined area.

Another useful feature that can be implemented at the EOC stage of the system is the use of moving areas of concern. A weather emergency provides a good example of when such a feature would be desirable. When a dangerous weather system is moving through an area, the defined geographic area of concern should move with the weather system. The current invention can readily accomplish this task by allowing an operator to define a movement pattern for an area of concern based on a prediction of how the area is likely to change over time. The operator also would retain the ability to override predicted movements if the actual conditions warrant (e.g., is the storm dissipates before reaching certain areas).

Similarly, the mapping features of the system can provide an operator with current and predicted weather conditions, so that such conditions can be taken into account in the determination of the geographic area of concern. Even if a moving area of concern is not used, it is often helpful to know what the weather conditions are and will be in the near future. A good example might be an accident causing the release of a dangerous gas. The current wind conditions can be the most important factor in defining the area of concern for such an emergency.

It is desirable to encode the geographic area data in such a manner to limit the size of the message that must be transmitted to and from the emergency system satellite 14. A larger data volume will require more memory resources on the satellite 14 and in the EAEDs 20. In addition, the larger the size of the transmission, the longer the transmission will take. The time difference is not likely to result in a noticeable delay in the response time of the system, but a longer satellite transmission is more vulnerable to interference or interruption than brief transmissions. In addition, the devices that ultimately receive the message may not have a great deal of internal memory, and may even be configured to limit the size of messages. For these reasons, it can be desirable to limit the size of the geographic area message.

The geographic area data can be compressed to reduce the size of the data transmitted. Such data compression can be done in any suitable manner. Numerous types of digital data compression are known to persons with skill in the art, and no particular method is known to be superior to another for the purposes of this invention. For operational consistency, it is highly preferred that a single data compression scheme be adopted and used by all EAS operators.

The compressed geographic area message is transmitted to the emergency system satellite 14 and is then retransmitted to EAEDs 20. In a preferred embodiment, the EAEDs are capable of decompressing the geographic area message. To avoid having to program the EAEDs 20 to recognize and decompress multiple types of data compression, it is, again, highly preferred that a single data compression scheme be adopted and used by all EAS operators. Using a small number of dedicated emergency alert transmission centers 12 would facilitate this objective, because the data compression could be performed by the emergency alert transmission center 12, rather than by the EOCs 22.

The emergency system satellite 14 can store the received emergency alert message and geographic data message for repeated retransmission to earth for some period of time. This can improve the effectiveness of the system by increasing the chances that EAEDs 20 within the geographic area of concern would actually receive the required messages. The satellite 14 can also be able to receive and transmit multiple messages simultaneously.

In addition, the satellite 14 can alter the format of the messages before retransmission, can modify or remove the data compression, or perform other changes to the digital characteristics of the emergency alert message and/or the geographic area message. These types of changes are all within the scope of the present invention, and would still constitute a retransmission of the messages by the satellite 14. As long as the same message content (i.e., the same emergency alert message-for example, to evacuate the area-and the same geographic area of concern) is transmitted by the satellite 14 to earth, such transmission is considered a retransmission of the same messages sent to the satellite 14 from the emergency alert transmission center 12.

In another embodiment of the preferred invention, the EOC 22 provides non-digital geographic area information to the emergency alert transmission center 12, where the geographic area information is then digitized and compressed. For example, the EOC could provide a verbal or written description of the alert area to the emergency alert transmission center 12. The operator at the emergency alert transmission center 12 can then use mapping software to define the geographic alert area, and the geographic area of concern would thus become an appropriate digital, and compressed, geographic area message signal, ready for transmission to the emergency system satellite 14.

The shape of the geographic area of concern can impact on the size of the geographic area data packet. A circular shape is easy to define digitally and produces a relatively small file size. A convoluted shape with numerous rectangular segments, on the other hand, can be quite difficult to define digitally, and can result in a very large file size. In some instances, it can be preferable to transmit multiple sets of geographic area and alert messages, with the entire geographic area broken down into more easily defined areas. This type of variation, and others intended to facilitate reliable operation of the EAS are within the scope of the present invention.

FIG. 3 represents the next general step of a method of a preferred embodiment of the present invention. This drawing illustrates the emergency alert message selection process 34. In the example shown in FIG. 3, the operator can select from certain standardized alert messages (e.g., evacuate or shelter in place) or can create a custom message. In addition, the present invention contemplates alert messages in text, audio, graphics (e.g., photographs, symbols, or icons), video, or any combination of these communicative methods. For example, an alert might consist of a text message, an audio version of either the same message or a more detailed message, and a video presentation showing a map of the alert area and safe areas.

The emergency alert message can be generated using computer software with a pull down menu 36, as illustrated in FIG. 3. Other means of generating an emergency alert message can include using codes representative of preselected messages and communicating the codes to an emergency alert transmission center 12, where the actual electronic message could be created. Similarly, an operator at the EOC 22 could call in the emergency alert message to the emergency alert transmission center 12, or e-mail or other communication means could be used.

The alert messages can contain more than the alert. For example, each alert message can include a unique serial number identifying the message. This would allow the EOC, satellite, and EAED to identify and distinguish between different messages. This capability could be used to allow the system to retransmit the same alert many times without a user receiving repetitious alerts. If the user's EAED recognizes, by the serial number or other unique identifier, that the message already has been presented, the EAED would not continue to present that same message repeatedly. Validation or authentication information can also be included with the alert message, to ensure the satellite only retransmits valid, authentic alert messages to EAEDs. Error coding can also be included to allow the satellite to detect when a corrupted message is received.

The system also can allow an EOC operation to send an alert message immediately, at a later, predetermined time, or to resend the same message periodically for some period of time (e.g., every five minutes for one hour). The later practice may not be needed often with the present invention because the EAEDs can store received alert devices for a designated time so that such messages can be provided if the EAED moves into the geographic area of concern. For example, if a user's EAED receives an alert message and a geographic area message, but the user is currently outside the geographic area of concern, the EAED would not provide the alert to the user. But if the alert message has a tag indicating it is to be saved for one hour, the user would be notified if he entered the geographic area of concern within one hour of receipt of the alert message. This capability reduces the need to retransmit the same alert message repeatedly. This capability also ensures a user will receive relevant alerts immediately, or nearly immediately, upon entering an area of concern.

The system can provide emergency alerts in multiple languages. EAEDs can provide the operator the option of selecting a language. It also can be desirable to provide EAEDs with the capacity to communicate alerts to deaf and blind persons. Visual displays and speech to text technologies could be used to ensure a deaf user receives emergency alerts. Audible alerts could be selected by a blind user. Text to speech technology could be used for this purpose. A vibration system for EAED's carried by users could be used to inform the user that an alert message has been received.

In another embodiment, the system can allow operators to save newly created alert messages so that the messages can be quickly accessed in the future. The use of speech to text technology could be used to provide a printed copy of a draft alert message, which can provide for more efficient review of the message before transmission. Conversely, text to speech technology could be used at the EOC stage of the system to provide verbal alert messages in addition to text messages.

The EOC part of the system can log all messages sent and save all data (both the alert and geographic portions). Reports can be printed showing what alerts were issued, where they were directed, and when they were transmitted. These capabilities can enhance training and improvement at EOCs.

The EOC or the alert transmission center, if it is a separate facility, can perform authentication communications with the satellite before an alert message is transmitted. By authenticating the link-up in advance, the satellite can more quickly receive and retransmit the alert message. In general, an alert sent using the system and method of the present invention should take no more than 120 seconds (i.e., two minutes) to be received by all EAEDs within the geographic area of concern. This is much faster than existing systems, and it provides the ability to reach a far greater percentage of the public.

In a preferred embodiment, the geographic area message and the emergency alert message are linked in some manner, if not combined into a single packet. Both messages also can be compressed, so that all data transmitted to the satellite is sent in compressed form. The two messages are related to each other, and will be transmitted and retransmitted as a pair of messages, or in some embodiments, as two parts of a single composite message. These variations do not deviate from the invention. In one preferred embodiment, these messages are linked by cross-reference data that allows the two messages to be positively correlated to each other by any device used in the EAS. For example, the transmitter, the satellite, and the EAED all would be capable of recognizing a pair of linked emergency alert and geographic area messages.

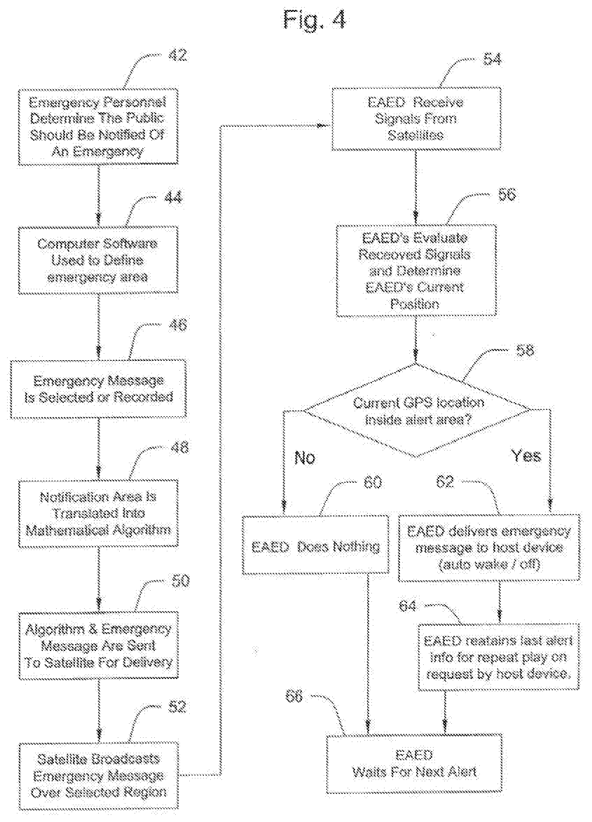

Turning now to FIG. 4, a flow chart 40 is presented. This chart depicts steps of a preferred embodiment of the present invention. The first step shown is the determination by emergency personnel that some segment of the public should be notified of an emergency 42. Once this determination has been made, an operator defines an appropriate emergency alert area using computer software 44. An appropriate emergency alert message then is selected or created by an operator 46. The geographic alert area is converted into a mathematical algorithm for the geographic area signal 48. The geographic data can be compressed as part of this step or an additional data compression step—not shown in FIG. 4—can be used.

This system and method can be used to alert all persons within a geographic area of concern, or it can be used to send alerts to only certain groups. The EAEDs can be programmed to recognize a unique identifier associated with the user of the device or with a group to which the user belongs. Alert messages transmitted using the present invention could use such unique identifiers to single out persons or groups for receipt of targeted messages. This use of a unique identifier could be an alternative to, or in addition to, uses relating to message authentication or corruption. The latter uses were discussed in a preceding part of this description.

The configuration of the system and method described here involves messages that are limited to a geographic area and a particular group of persons within that geographic area. If, for example, there was a need to alert all emergency responders within a certain region, the present invention could do that. The appropriate alert message and geographic area message would be created, and an additional unique identifier—an identifier associated with all emergency responders, but with no other group—would be linked to one or both of these messages. The unique identifier would be transmitted with the messages, and would be received by EAEDs. Only those EAEDs that meet the identity requirement would transmit the alert.

To be more specific, consider a decision by a particular state to activate its National Guard. An appropriate alert message could be prepared-for example, “Report to your National Guard post for further orders.” The geographic area message in this instance can be limited to the state calling up its National Guard, or might cover all of the United States. The latter option can be desired, given that some Guard members may be outside the state when the activation is ordered. Finally, a unique identifier associated with members of the National Guard of the activating state would be added to, or linked to, the alert message, the geographic area message, or both.

The EAEDs used by the National Guard members would be programmed to recognize the unique identifier associated with the National Guard, and would present all messages received that match the area requirement and the identity requirement. Because many persons may be members of various groups, it is anticipated that many EAEDs will be programmed to recognize multiple unique identifiers. This configuration is relatively simple to implement, and the use of multiple unique identifiers in an EAED would not burden the memory or processing capacity of the device.

To take another example, consider a wildfire in a Western state. There are many trained, volunteer firefighters in the Western United States who assist when there is a large wildfire. The present invention could be used to reach all such firefighters within a certain distance of the wildfire. In this instance, the geographic targeting and the identity targeting of the present invention are combined. Moreover, the present invention would allow for rapid dissemination of the message to all members of the relevant group.

To implement this capability, it is necessary that members of important groups ensure their EAEDs are properly programmed. This could be done during the training, certification, or licensing of such persons. There could be periodic tests of the system, where each group member is instructed to respond to confirm receipt of the test message.

The capability to utilize identity-based, geographically-targeted alert messages, as described above, provides a great deal of flexibility. For example, in some circumstances, users, or groups of users, can be allowed to opt in or opt out of this service. In other circumstances, the service can be mandatory for certain users or groups of users. The priority of the alert can also be used as a basis to allow users to opt in, opt out, or opt for delayed message presentation. The latter option might allow a user to review lower priority messages at a convenient time, rather than having such messages interrupt other activities.

The combinations are essentially endless and can be tailored to fit the needs of each particular group or user. The combination of real-time geographically targeted alerts to certain groups can be advantageous in numerous contexts. It might facilitate in the call-up of reserve military forces or in an effort to reach all emergency responders, as in the prior example. The technology might also have commercial applications such as geographically and demographically targeted real-time marketing. This capability might be used in political campaigns to reach all campaign workers within a particular region. The commercial applications of the technology, however, should be secondary to the emergency alert purpose of the system.

A computer can be used to digitally encode the geographic area of concern. As there is no current standard format for geographic mapping algorithms, the invention is not limited to any particular format type for the geographic data. Computer software can be used to create a digitized representation of the geographic area of concern. This digital file would be part of, or perhaps all of the geographic area message transmitted to the satellite and subsequently retransmitted to the EAEDs 20.

The alert and geographic data also can be transmitted to some EAEDs via the Internet. This transmission method could be particularly suitable to persons using GPS enabled smart phones, laptop computers, or netbook computers, all of which often have access to wireless Internet service. With an EAED embedding within such a product, the alert and geographic messages could be received via the wireless Internet signal, and the real-time GPS data used to determine whether the device is within the area of concern.

Once the appropriate alert message signal and geographic area message signal are prepared, these two sets of information are transmitted to one or more satellites 50. The satellites then broadcast the emergency message signal and geographic area message signal to a selected region 52. These broadcasts will cover a much larger geographic region than that selected by the emergency system operator in order to ensure that the entire geographic area of concern is fully covered by the broadcasts. For example, if the emergency alert area includes a part of Houston, Tex., the satellite transmissions might reach users throughout North America. Other satellites broadcasting to other parts of the world would not be used in this example. It is anticipated, however, that use of more than one satellite can be desirable to provide redundancy and thus increase the effectiveness of the invention.

An EAED 20 then receives the satellite transmission of the alert message signal and the geographic area message signal 54. The EAED 20 can use an authentication process to ensure the incoming messages are legitimate. Once these two signals are received and authenticated, an EAED 20 will evaluate the geographic area message and compare the geographic data contained in that message to the EAED's current geographic location 56. The EAED 20 can use a variety of means for fixing its geographic location, but a preferred means is use of the global positioning system or GPS. This is discussed in more detail below. The EAED 20 then performs a decision step. It asks whether the EAED 20 is within the geographic area of concern 58.

If the EAED 20 is outside the area of concern, the process ends 60. If, however, the EAED 20 is within the geographic area of concern, the EAED presents the emergency alert message 62. The EAED 20 then saves the message for repeat play upon request by a user 64. The message is presented even if no user is there to receive the message. The means of presentation will vary depending upon the interface used by the EAED and/or its host device. If the alert is limited to certain persons (e.g., all police offices or all reserve military), then only those EAEDs 20 used by such persons would present the alert message.

In the most preferred embodiment, the EAED 20 is embedded within a host device. If the EAED 20 is required to deliver an alert message 62, the host device can be used to present the message to the user. In the event the host device is in use for some other purpose, the EAED 20 would override the current operation of the host device so that the emergency alert message is delivered. In the event the host device is turned off when the EAED 20 determines that an alert message is to be delivered 62, the EAED 20 would turn on the host device and deliver the message. The host device can be turned back off again after the alert message has been delivered.

An EAED can be configured to determine is geographic location. But, EAED devices need not require the ability to directly determine their own geolocation. Rather, an EAED can be configured to communicate with other devices, for example via Bluetooth, Wi-Fi, or other media. Such communication can provide locational awareness, e.g. whether the EAED is tethered or otherwise in proximity to hand held devices, laptops, netbooks, pads, automobiles, etc., which can provide locational information. In other words, by configuring an EAED to determine its geolocation, what is contemplated is that the EAED need only be capable of obtaining such information; it need not be specifically designed to analyze geolocation information. A current location can be stored periodically for geolocation discrimination purposes. For immovables, such as home alarm systems, desktops, entertainment devices, and other home appliances, semi-permanent information is often set upon initial installation, and such information can also be used by an EAED to determine the approximate location of the EAED. For some immovables, such as appliances or home electronics, a “checking for current location” process can happen periodically, e.g. monthly, quarterly, annually or some other time period as needed or preferred. An EAED can be configured to access such location information.

Locational and/or situational awareness can also be obtained from aircraft, such as unmanned aircraft. There has been a dramatic increase in the use of drones, and few restrictions currently exist to inhibit continued growth. For example, the Federal Aviation Administration (FAA) has historically been uninvolved with unmanned aircraft that operate below an altitude of 500 feet, and radars can have limited effectiveness for low altitudes, e.g., below 1500 feet. An EAED can be utilized for communicating with drones operating in such airspace to improve situational awareness for drone operators. For example, as depicted in FIG. 14, an aircraft 147 can be equipped with the ability to send a point to multi-point one-way broadcasts that alert other aircraft of its presence. Other aircraft in the area can receive the message for improved situational awareness. Additionally, if a drone is in the targeted alert area, the drone can communicate alert information to the drone operator 148. The communicated alert can be received by a receiving device within, for example, the drone operator's remote controller and/or can be received by the operator's mobile device, such as a cellular telephone. Aircraft in other airspace, such as Class E controlled airspace or restricted air space, can also incorporate an EAED utilizing, e.g., a point to multi-point one-way broadcast, such as terrestrial, aircraft, and/or satellite based communication systems, to deliver data packets containing an alert message and/or geographic coordinates of a targeted alert area. Aircraft can be equipped with the capability to receive the broadcast transmission and compare its location to that of the alert area. If the aircraft is in the alert area, for example, the aircraft can communicate such a message to the operator. The communication can be received by the operator, for example, from an in-vehicle system and/or via wireless transmission to the operator's mobile device, e.g., via a Bluetooth or similar connection. Such wireless configuration can be utilized, as depicted in FIG. 14, in any EAED-implemented vehicle system, such as with an automobile and/or with an aircraft.

An EAED can be configured to utilize data about a user gathered from, e.g., wearable technology for message discrimination purposes. Information can be health related, environment related, or other. The EAED can be implemented within a device that is worn by, carried by, or implanted within a user having a unique user identifier. The EAED can be configured to transfer data over a network without requiring human-to-human or human-to-computer interaction. The EAED can obtain and/or transmit such data autonomously or semi-autonomously.

Whether the alert message is delivered 62 or not delivered 60, the EAED 20 returns to ready mode 66 following execution of the preceding steps. In fact, the EAED 20 remains ready to receive messages at all times, and in a preferred embodiment, has a buffer or queue to hold incoming messages while other messages are being processed. This is potentially important because it is possible that a particular EAED 20 could receive numerous messages within a very short period of time. The present invention allows for this, and ensures that any alert message that needs to be delivered to a user will be delivered. In practice, an EAED 20 would take just a few seconds to process a number of alert message/geographic message pairs.

The EAED 20 should be capable of receiving alerts when the device is indoors, in a congested city area with numerous high-rise buildings (i.e., a so-called “urban canyon”), and during all types of weather. Preferably, the EAED will be able to obtain both GPS and alert messages in all these settings, but in the event a real-time GPS signal is not available, it is important that the EAED still be able to receive all alert messages. When this possible, though not desirable, situation occurs, the EAED would use the last reliable GPS location data to determine whether the device is within the geographic area of concern.

The hardware or firmware used by the EAED 20 should be upgradable. This capability allows a user to update the firmware to the most recent version and thus enhances the service provided. This capability also extends the useful life cycle of each EAED.

In a preferred embodiment, an EAED will use a two-step process to determine whether the device is within the geographic area of concern. Step one is a cursory check—a check that can be performed very quickly and with minimal processor use—to determine if the device is located within a large region that includes the geographic area of concern. This cursory check is a crude check using location parameters less precise than those needed for an accurate location fix. But this check can be done quite simply and quickly. By including this step, a large number of emergency alert enabled devices will be quickly excluded from the area of concern, thus preventing those devices from performing needless processing of the more specific location data.

If step one indicates the device is at least near the area of concern, step two would then be an accurate check of the real-time GPS location to determine whether the device is actually within the area of concern. This approach allows the device to quickly and efficiently weed out messages intended for remote areas.

An example of this two-step process helps illustrate the concept. Consider a geographic area of concern that includes three counties in Kansas, a state in the central United States. Step one of the processes described above might determine whether the emergency alert enabled device is located within a range of latitude and longitude coordinates that encompass the entire central United States. Alternatively, step one could compare the first digits of the latitude and longitude of the emergency alert enabled device's most recent GPS fix to the coordinates of the geographic area of concern. These crude, initial checks could be used to screen out emergency alert enabled devices that are far away from the geographic area of concern.

A variety of different alerts types can be used. For example, alerts could be prioritized, with the highest level corresponding to life-threatening situations; level two could be reserved for severe property damage situations; level three for traffic alerts; level four for amber/silver alerts, weather alerts that are not within higher-priority categories, and other less severe situations. Alternatively, the alerts could be linked to the color-coded alert system developed by the United States Department of Homeland Security. Alert categories and priorities can be set by the relevant operational authority.

The use of real-time GPS information, combined with the ability to store previously received alert and geographic area messages provides another important capability that is not available using other technologies. The current invention can provide a relevant alert to a user who was outside the alert area when the alert message was transmitted, but who enters the alert area while the alert remains active. When the EAED recognizes that it is moving, it can compare its GPS location over time to all geographic areas of concern for active alerts. By doing so, the EAED would recognize when a user has moved into a geographic area of concern, and would then provide the relevant alert message.

The converse is also possible. That is, when a person who is moving leaves the geographic area of concern, the EAED would recognize this fact and would stop triggering the alert message for that area of concern. This capability greatly enhances the utility of the present invention. It reduces over inclusive emergency message presentations and avoids under inclusive presentations, too. The invention has the ability to notify all persons within the geographic area of concern on a dynamic basis.

To take this capability one step farther, an EAED could be programmed to inform a moving user that he or she is approaching an alert area before the area has been entered. A more stem warning could be used as the person gets closer to the alert area. On the other hand, when a person is leaving an alert area, the EAED could be programmed to inform the user that he or she has just exited the alert area and is out of danger. This feature could be used when the alert area is moving, when the EAED (i.e., the user) is moving, or both.

For example, consider a hurricane evacuation order based on the predicted path of a storm. As the storm moves, the alert area can change. As a person begins evacuating the area, that person's EAED would also move. The present invention can provide updated information to the user based on changes to his or her location and changes to the storm warning area. Not only could this allow users to realize when they have left the evacuation region, but it could also inform persons who might be evacuating in the wrong direction. This could occur if a user is traveling the same direction the storm has shifted towards. The present invention could be used to inform this user that the storm warning area has shifted in the same or a similar direction to the direction the user is currently traveling. This type of alert would warn such a user to take a different evacuation route. These types of dynamic capabilities of the present invention are not possible with other technologies.

The dynamic capacity of the present invention also could be used to determine when users are traveling and by what means. If the EAED is moving at high speeds (e.g., greater than 150 miles per hour), the device can confirm that the user is flying. If the EAED is located on a road and is moving, the user can be assumed to be in a motor vehicle. This additional information could be used to determine whether certain alerts should be provided to such users.

All clear alert messages can be used, too. Such messages would be transmitted to all persons within the prior area of concern to inform them that the threat has passed. Similarly, if the threat level changes (either up or down) such changes can be readily and efficiently transmitted to all persons within the relevant geographic area. The invention could be configured so that all clear messages are only presented to users who received the prior alert message.

When an EAED 20 is embedded within a cell phone, an incoming alert can be treated as an incoming call, thus triggering call-waiting and caller-identification features available on many such phones. Alternatively, if the user is making or participating in a call at the time an alert is received, the invention could be configured to provide some type of warning without blocking or overriding the user's phone call. This capability could be used only if the incoming alert is of high priority, where, for example, the EAED could present a momentary audible warning signal to the user, a display that a high priority emergency alert message has been received, or any other means of contemporaneously notifying the user of the fact that a high priority alert has been received without overriding the user's call. On phones with the capability, an incoming alert can be displayed as a text message without interrupting a call in progress.

All EAEDs would be able to receive messages, even when the host device is turned off. This ensures that no alerts are missed. If a relevant alert is received when the host is off, the host is switched on and the alert message is presented to the user. Or if the host device was in a different mode (e.g., a car stereo playing a CD or a cell phone playing an MP3 music file), the host is changed to the alert display mode and the alert is presented. After the alert message has been presented, the host device could be switched back off or returned to its prior operating mode. This capability could be limited to only high-priority alert messages or to other types of messages selected by the user (e.g., traffic alerts). Similarly, certain lower-priority alerts might be presented only during hours the user is expected to be awake. Most users would not want to be awaken at 3:00 am to be informed that there has been an accident on a nearby freeway, unless, of course, the accident caused the release of a dangerous chemical, started a large fire, or caused other more serious results.

Uniform alert tones can be used to ensure users become familiar with the warning signals. A few different and clearly distinct tones could be used to identify different categories of alerts. EAEDs should be required to participate in periodic system tests. This operation is important to ensuring the proper operation of the EAED and the overall system.

Though the present invention is expected to have it highest utility as an emergency alert system, it also has other commercial applications. Commercial data (of small size) could be transmitted to users within certain areas. If the users' EAEDs have been preset with unique identifying codes, commercial messages could be targeted to users of certain types within certain areas. This capability could be used for highly targeted advertising, though this use should not be allowed to reduce the effectiveness of the system as an emergency alert system.

The present invention also could be used to allow users to subscribe to certain news or information feeds or services. Breaking news, stock market information, sports results and other such information could be provided using the present invention. The present invention could disable such services when the device is moving within a certain speed range (e.g., the range of speeds typically used in motor vehicles).

Clubs, groups, and employers could use the present invention to reach all persons within certain areas. For example, a large employer could advise all workers within a certain region that they should not report to work because of bad weather conditions.

Schools could use this feature to advise parents and students of school closure days. Even political candidates and campaigns could use the present invention to target voters within certain areas with messages tailored to such areas. Or campaign workers within a particular area could be advised of the need to work on a certain project.

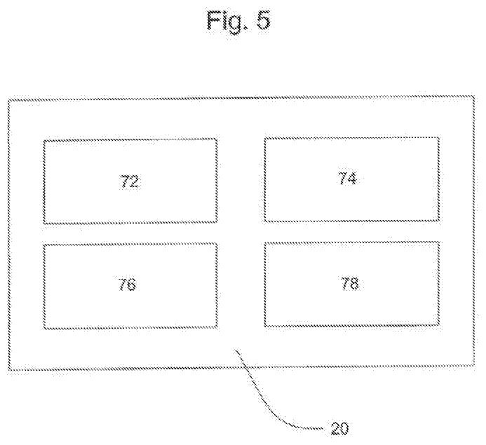

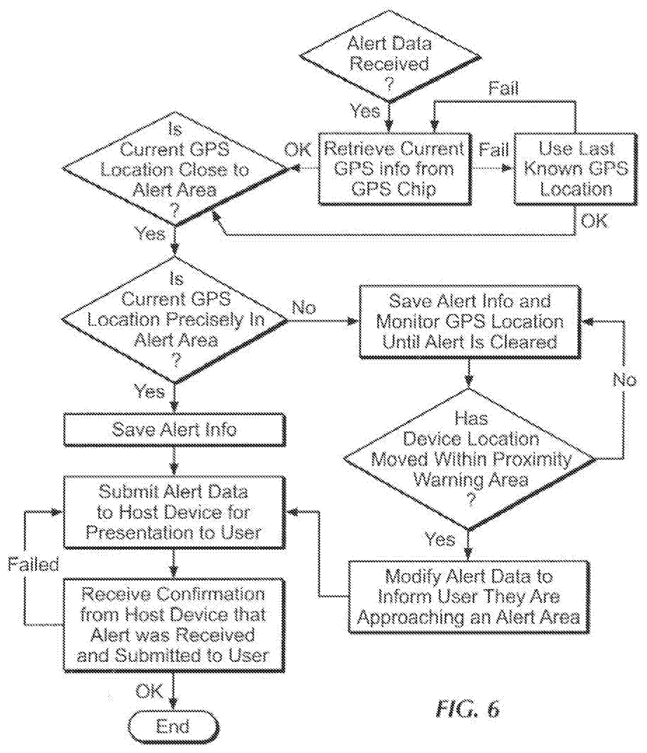

A block diagram of an EAED 20 is shown in FIG. 5. The blocks represent a geographic position module 72, a satellite message receiver 74, an emergency alert message interface 76, and a data processor 78. The geographic position module 72 in a preferred embodiment is a highly-sensitive GPS receiver. Because the EAED 20 must remain on at all times and must be capable of fixing geographic position even when a user is indoors or under heavy tree cover, there is a need for a GPS receiver with very high sensitivity and very low power consumption.

GPS receivers satisfying these requirements can be obtained from a variety of sources. One model that has worked well is made by u-blox, a German company specializing in GPS technology. u-blox makes a variety of GPS receivers, and has developed extraordinarily sensitive receivers. GPS satellites must transmit continuously, and for this reason, these satellites transmit at very low power levels. This has caused reception problems with GPS receivers in the past. Many GPS units lose their signal when the unit is inside a vehicle, under dense tree cover, or indoors. In addition, many GPS units are slow to acquire a position. It is highly desirable to avoid such shortcomings in the present invention.

The u-blox GPS receivers combine highly sensitive antennas with sophisticated data processing. Some u-blox receivers include a dead reckoning feature that helps estimate current position of a unit even if GPS satellite data is momentarily lost. In addition, the u-blox GPS receivers are ultra-low power consumption devices, using less than 50 mW of power. The u-blox 5 is the latest generation u-blox GPS chipset, and it is expected that this chipset would work well with the present invention. u-blox claims that this chipset acquires a GPS fix in less than one second. Quick and accurate fix acquisition is highly desirable for the present invention.

If a GPS fix can be reliably obtained very quickly, it is possible for the geographic position module 72 to power down during regular operation of the EAED 20. The geographic position module 72 could obtain a GPS fix on a periodic basis, and could be configured to obtain a fix when a geographic area message and an emergency alert message are received from a satellite. Such operation can reduce the power consumption of the geographic position module 72, and thus reduce the overall power demands of the EAED 20.

The invention will work with any low-power, high sensitivity GPS receiver. The u-blox receivers are a currently preferred embodiment, but there is a great deal of competition within the GPS receiver market. In addition, a new generation of improved GPS satellites will be put into operation in the future. These new satellites will have higher transmission levels than the existing GPS satellites. When these new satellites become available, the sensitivity concern may be less important than it is today. The power consumption concern, however, may remain important, particularly if the EAED 20 is configured to remain powered up at all times.

The satellite message receiver 74 includes components necessary to receive the alert message and geographic area message from the emergency system satellite 14. Existing technologies used in satellite radio, satellite pagers, or satellite cell phones could be used for this purpose. It is desirable for the satellite receiver to be highly sensitive and consume minimal power. The satellite message receiver 74 can operate in a sleep mode until a signal is received, thus conserving power.

The satellite message receiver 74 must have sufficient sensitivity to reliably receive satellite signals even when indoors, inside a car, or in other situations where there is no clear line-of-sight to the transmitting satellite. This concern is less limiting than the GPS sensitivity issue discussed above because the satellites used by the EAS are likely to transmit substantially more powerful signals than do existing GPS satellites. Satellite pagers and satellite phones have good performance even when the receivers are indoors, and these technologies, therefore, are preferred for the present invention. Satellite radio, in its current state of development, tends to suffer from frequent signal loss, and for that reason, is not currently preferred for this invention. As with GPS receiver technology, it is expected that competition will lead to improvements in the satellite radio receiver technology, and this type of technology can be a good match for the present invention in the future.

The geographic position module 72 and the satellite message receiver 74 both require a satellite antenna in the most preferred embodiment. Separate antennas could be used, or a single, dual-use antenna could be used. In either case, the antennas selected should have the highest possible sensitivity. In some applications, the host device (i.e., the device in which the EAED 20 is embedded) can have an existing antenna that would provide superior performance and that could be shared by the EAED 20.

The data processor 78 performs the needed analysis of the incoming geographic data received via the satellite message receiver 74 and the current geographic location information received via the geographic position module 72. An evaluation is performed to determine whether the current geographic position of the EAED 20 is within the geographic area of concern. If so, the data processor 78 then sends the emergency alert message to the emergency alert message interface 76. This interface 76 either directly or indirectly presents the emergency message to a user. The data processor 78 also includes sufficient memory to store prior alert messages for replay at a later time. Alternatively, such memory could be provided in a separate module within the EAED 20.

The EAED 20 could be a stand-alone unit or could be embedded within a host device. The latter arrangement is preferred. A wide variety of host devices are contemplated for the present invention. Automobiles, cellular phones, land-line telephones, computers, televisions, radios, MP3 players, and almost any existing or later-developed device that provides text, audio, or video content to an end user. If, however, the EAED 20 is a standalone unit, the device must also include some means for communicating directly with a user. This could be a visual display screen (e.g., a small LCD display) or an audio system.

To more fully appreciate the operation of the present invention, consider its use in an automobile. The EAED 20 could be incorporated into the design of the automobile in a seamless manner. With a small footprint, low power consumption, and the relatively large source of power via the automobile's large starter battery, the EAED 20 would raise minimal design challenges for an automobile designer. The EAED 20, for example, could be incorporated into the vehicle's stereo system or into a navigation system, if the vehicle was so equipped. The EAED 20 might use an existing antenna on the vehicle to improve satellite reception. The EAED 20 could interface with the audio system in the vehicle to present audio alert messages or with the warning light and/or alarm system to warn the user of the emergency. An exemplary configuration is depicted in FIG. 14. In this configuration, a vehicle 149 can receive a transmission and then alert a driver or passenger 150 of an alert message. Many vehicles today have visual displays capable of presenting text messages, and such a capability could be used by the EAED 20 to communicate emergency messages. If a relevant emergency message is received while the vehicle is not in use, the EAED 20 could store the message, and present it to the user the next time the vehicle is used.

If an EAED 20 is embedding into a cellular phone, the invention could interface with the phone to provide audio, text, and potentially video emergency message content. A unique emergency alarm ring-tone could be used to ensure the user recognizes the urgency of the event. If the phone is in use, the EAED 20 could override the existing use and convey the emergency alert to the user.

Embedding an EAED 20 into a television, radio, MP3 player, or other device with some form of audio and/or visual interface is also expected. When an EAED 20 embedded within such a device receives a relevant message, it could turn the device on and convey the alert message. The device could then be turned off again. The message could be stored until a user later turns on the device, at which point the alert message could be provided again.

When the EAED 20 is embedded in a host device that is capable of receiving signals outside the normal transmission bands, the system of the present invention could make use of such bands, and thus reduce interference from other signals. This capability exists for radio transmissions by using sub channels. These sub channels are broadcast spectrum that is current used to send song or other data, but not audio signals. Similarly, television sub channels exist for sending close captioning and other data. These sub channels could be used by the present invention to transmit alert and geographic messages to emergency alert enabled devices embedded in these types of host devices.

The EAED 20 and its host device could be configured to operate regardless of the mode of operation in use at the time. For example, if an EAED 20 is embedded in a television and a movie is being watched via an alternative input, the EAED 20 would still prompt the television to provide the alert message. This capability shows one important advantage the present invention offers over the existing emergency broadcast system (EBS). The EBS will reach only those persons watching a regular television broadcast. If, for example, a user's television is on a Video One input receiving a feed from a DVD player, the EBS cannot reach that user. The EAED 20 of the present invention, however, would reach that user.

The present invention uses satellite transmissions in a preferred embodiment, but is not limited to such use. Other transmission means are also expected, including Internet, cellular, WMN, Wi-Fi direct, land-line phones, and so forth. Further, the messages of the present invention can be broken into parts for transmission and then reassembled by the emergency alert enabled device. Unique identifiers for each part would be assigned to ensure the emergency alert enabled device can proper reassemble and authenticate the full messages before evaluating the messages.

The different parts of a message can be broadcasts via different means. For example, a message can be broken into three parts. All three parts can be transmitted via satellite, Internet, cellular systems, WMN, or Wi-Fi Direct. The emergency alert enabled device can receive one part of the message from a satellite, one part via the Internet, and one part through a cellular transmission, which could be any form of cellular transmission (i.e., voice, text, or data). The emergency alert enabled device can receive the message parts through different transmission means and properly reassemble and authenticate the messages.

The emergency alert enabled device is further capable of ensuring the transmissions via multiple means do not result in unwarranted repetition of the alert to the user. For example, a certain alert message might be received by the emergency alert enabled device via satellite and cellular transmission. The emergency alert enabled device would recognize that it is the same alert, using unique identifier data provided with the message, and process the alert as a single message. The message would be presented to the user according to the 5 standard presentation protocol of the emergency alert enabled device's firmware, and no repetition due to the multiple transmission means would result. The alert can be presented more than once, but that would occur only if such repetition was warranted, as determined by the emergency alert enabled device's firmware. This process is described more below.

Though the present invention is described as relying primarily on GPS location data, the EAEDs can also be used as an alternative location fixing means. For example, various location fixing processes have been developed using cellular transmission information. If a particular cell phone receives and responds to transmissions from multiple cell towers, a triangulation process can be used to obtain a location fix on the cell phone. The accuracy of such fixes varies a great deal, but it does provide another means of fixing the location of an EAED used in a cell phone. Additionally, Wi-Fi devices and towers can be utilized interchangeably.

At least two modified GPS systems have been developed for cell phone users. These systems typically combine a number of features to provide real-time GPS fixes to cell phones. The cell tower locations are precisely fixed, giving a particular cell phone a reference point for the GPS fix process. The GPS satellite data can be stored and transmitted through the cellular system, rather than directly from the GPS satellites, thus reducing the time needed to obtain an accurate fix. Present embodiments can utilize microcell, macrocell, picocell, and femtocell base stations. For clarity, a macrocell is a cell in a mobile phone network that provides radio coverage served by a high power cellular base station (also called a tower). Macrocells typically provide coverage larger than microcell. A microcell is a cell in a mobile phone network served by a low power cellular base station (tower), covering a limited area such as a mall, a hotel, or a transportation hub. A microcell is usually larger than a picocell, though the distinction is not always clear. A microcell uses power control to limit the radius of its coverage area. A picocell is a small mobile phone base station connected to the phone network via the Internet, typically used to improve mobile phone reception indoors and considered to be smaller than a microcell. A femtocell, also referred to more broadly as a small cell, is a small, low-power cellular base station, typically designed for use in a home or small business. It can connect to a service provider's network via broadband (such as DSL or cable).

One such system is called assisted GPS (aGPS). It is used on some cell phones, and uses some of the features identified above. A more recent development is the enhanced GPS (eGPS) system. This system also uses a combination of the cellular system and GPS system to provide location fixes to cell phone users. Both systems help reduce the time to first fix and allow for location fixes in areas where GPS signals are otherwise be too weak. The current invention can use aGPS, eGPS, or any other later-developed improvement to the basic GPS system in order to provide more accurate and timelier location information to an EAED The invention is not limited to only use of the traditional, satellite only, GPS system to fix the position of an EAED

Another example of an enhancement to the GPS system is the satellite-based augmentation system (SBAS). This enhancement uses a network of ground-based reference stations to measure small variations in the GPS satellites' signals. These signals can vary slightly due to atmospheric conditions. The SBAS approach uses data from the ground-based reference stations to correct for atmospheric variations in the GPS signals. This enhancement was developed for use in aviation, where precise location and elevation data was needed.

The best known of the SBAS solutions is the Wide Area Augmentation System (WAAS), which is used in North America. WAAS uses ground stations located throughout North America and provides improved GPS performance to WAAS-enabled GPS devices within that area. Ocean areas surrounding North America are also covered, and as a result the WAAS capability has become popular with mariners and fisherman, too.

Similar systems have been developed in other regions. In Europe, there is the European Geostationary Navigation Overlay Service (EGNOS), and Japan uses the Multifunctional Satellite Augmentation System (MSAS). Other similar systems are used in other regions. The present invention can use any of the SBAS systems within the EAED to improve the location accuracy of GPS fixes. These systems would also enhance elevation data obtained by an EAED.

The use of elevation data by an EAED can allow the device to determine, for example, when a user is flying (i.e., when speed and elevation are high), which can be relevant in different ways. The EAED can switch to an airplane mode when such conditions are detected, and thus prevent presentation of most alert messages. Certain alerts, however, might still be presented. The EAED firmware would be programmed to provide the type of discrimination desired. Messages that should not be transmitted during flight could be coded in a certain manner, while emergency alerts that should be transmitted during flight might be coded differently. An example of a message that might be presented even during a flight would be a message that the plane is approaching a dangerous area or some other type of message directly relevant to persons flying. It is anticipated, that under current rules, few, if any, alert messages would be presented to users during flight. Such rules may change, however, and the present invention can be used in any manner appropriate to the existing rules and conditions.

GPS is widely used by the military, and this fact has led to use of GPS jamming technologies. Various anti jamming solutions have been developed. Boeing, Raytheon, Lockheed-Martin, and u-blox are but a few of the commercial providers of anti jamming GPS technologies. Technology is expected to continue to develop in this area. The present invention can incorporate anti jamming technology, of any sort, into the EAED.

The EAED can be constructed in a number of ways, and the present invention is not limited in this regard. In one preferred embodiment, all four of the blocks represented in FIG. 5 could be incorporated into a single chip. In another embodiment, the GPS capability can be present in the host device (e.g., a GPS-enabled cell phone of a dedicated GPS device), and the EAED would not need to provide duplicate GPS capability. In that situation, the EAED can include an interface to the existing GPS unit within the host device.

In yet another embodiment, the EAED might use three physical components: an antenna, a single chip GPS receiver, and a single chip EAED receiver. The two receiver chips might be separated for different reasons, including, for example, the possible presence of a GPS chip within the host device, as mentioned above. Both the GPS receiver and the EAED receiver would have certain common, general features. Both would have an RF signal processor to handle the incoming signals from the antenna. Both would have some internal memory, and both would have a processor. In a general sense, the single GPS chip mentioned here would represent the geographic position module 72, and the single EAED chip would include the satellite message receiver 74, the emergency alert message interface 76. Both chips could have a data processor, but the data processor 78, as shown in FIG. 5 would be within the EAED chip.

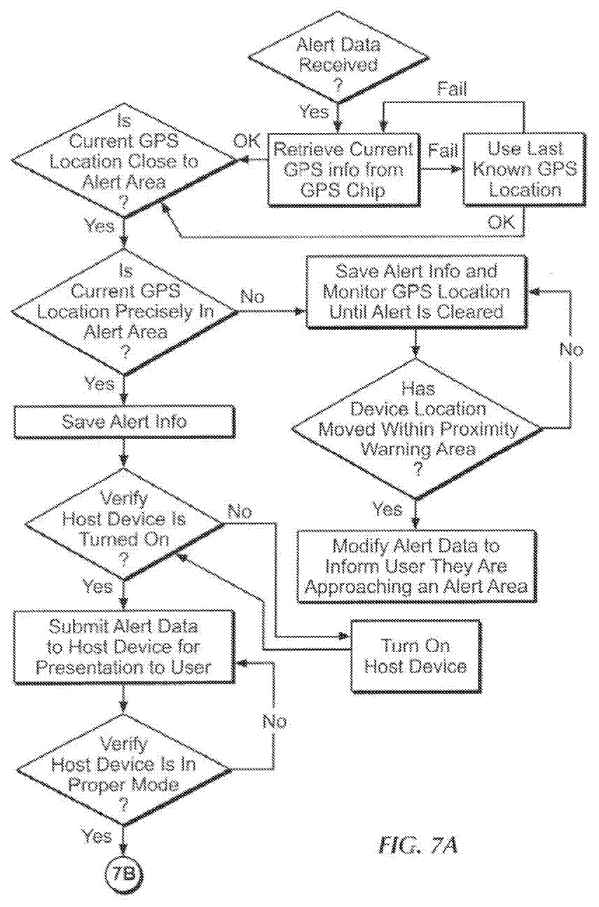

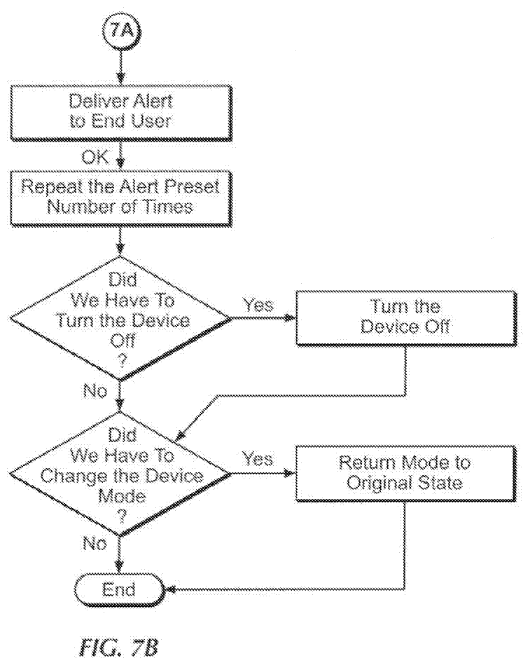

To better appreciate the operation of the EAED, flowcharts are provided in FIGS. 6 and 7. These flowcharts represent two basic modes of operation for the EAED. The firmware on the EAED would be constructed and programmed to perform the functions identified in the flow charts. FIG. 6 shows how the EAED would function with a “smart” host device, that is, a host device that is capable of communicating back with the EAED In a smart host, the host device can instruct the EAED that an alert message has been received by the user. For example, a user with a cell phone can click a “Yes” button on the phone to confirm receipt of an alert message. The cell phone (i.e., the host device) would then confirm receipt to the EAED In a “dumb” host, the ability to transmit from the host to the EAED is absent. This fact requires different operations by the EAED, as shown in FIG. 7.

Turning to FIG. 6, the flowchart begins with the satellite receiver. The alert data received step determines whether a full alert message has been received. This can involve comparing authentication data to stored data and it can also involve reconstructing an alert message sent in parts. An alert message could be sent in multiple parts via different transmission paths. For example, an alert might be broken into four parts, with one part received via satellite, one by cellular transmission, one by the Internet, and one by Wi-Fi or some other means. But whatever the process for getting the message parts to the EAED, the alert data received block represents the processing and reassembly of the message. If all parts of a message are received and reassembled into proper order, then this step leads to the retrieve current GPS info from GPS chip block. At this stage, the EAED checks for a current GPS location fix. Other means of obtaining a location fix can be used, and the GPS reference here is intended to represent a preferred embodiment and not a limitation on the scope of the invention. If no current location fix data is available, the EAED will use the last known GPS location data. In either event, the GPS data (or other location data) will be sent on to the comparison block At that stage, the EAED uses the geographic area component of the alert message and the location data to determine whether the EAED is close to the geographic area of concern. If not, the process stops and the message are not stored. In an alternate embodiment, the message could be stored for some period of time and rechecked to determine if the user is moving toward the alert area. This capability is not illustrated in FIG. 6, but is within the scope of the invention.

If the EAED determines that it is close to the geographic area of concern, a second check is made to determine if the EAED is precisely within the alert area. If not, the alert info and message are stored until alert is cleared. If this happens, the EAED will check to see if it is moving, and if so, whether it is moving toward the alert area. If the EAED is moving toward the alert area, a message to that effect is presented to the user. If the EAED is stationary or moving away from the alert area, the alert is saved and the EAED's position is checked periodically for movement toward the alert area. This aspect of the EAED's operations can be altered to fit the needs or desires of a user. For example, some users may want to be alerted if they are within a certain distance of an alert area, even if they are not moving or are moving away from the area. These types of choices can be programmed into the EAED firmware to suit a particular user's preferences. FIG. 6 shows only a basic version of a preferred embodiment.

Returning to the determination of whether the EAED is within the alert area, if the answer to that query is yes, then the alert information is stored. The alert is also presented to the user at this time. The EAED then looks for confirmation from the host device that the user has received the alert message (i.e., either the primary alert or a warning that the user is moving toward the alert or any other message presented). If the host device confirms that the user has received the message, then the process ends. If no confirmation is received, the EAED will periodically represent the message to the user via the host device. If no confirmation is ever received, this process will continue as long as the alert is in effect.

The flowchart shown in FIG. 6 is based on a smart host device that is in a proper mode for message receipt and presentation. A cell phone is a good example of such a device, when the cell phone is on. The phone can be in standby mode, but is still capable of presenting an alert message to a user, via text, voice, video, or some combination. If, however, the smart device is off, the present invention will still work. The EAED can have the capability to turn on the smart device to present a message. The EAED is always on, a characteristic explained more in the following description of an EAED designed for use in a dumb host device.

A similar process is used for a dumb host device, but the latter parts of the process are different because the host device is not capable of confirming receipt of the message. The satellite receiver functions to receive the alert message, with both the geographic message and alert message components. The EAED checks to see that a complete and authentic alert message has been received. It then checks the GPS data (or other location data). If no current location data is available, the last known data is used. The first comparison is then done to determine if the EAED is close to the alert area. If it is, a second geographic comparison is done to see if the EAED is within the alert area. If not (i.e., the EAED is close to the alert area, but not within it), the alert is saved and the GPS data is checked for movement toward the alert area. If such movement is detected, an appropriate message is presented to the user. If the EAED is found to be within the alert area, the alert message is saved.

At this point, the EAED checks to see if the host device is on. If not, the EAED turns on the host device (e.g., a television or car stereo). The EAED then checks to see if the host device is in the proper mode for presentation of an alert message. For example, if a car stereo is playing a CD, the alert message could not be presented. If the host is not in the proper mode, the EAED sets the device to the proper mode and then confirms that setting. The EAED then presents the alert message via the host device. The alert is presented periodically for a preset number of times or until the alert has cleared.

Once the alert presentations are completed, the EAED checks to see if it had to turn on the host device. If so, the EAED turns off the host device, thus restoring it to its former condition. The EAED then checks to see if it had to change the mode of an operating host device. If so, the EAED returns the host device to the prior operating mode. Once these restorative steps are complete, the process ends. These steps can also be used with the smart host to address hosts that can be turned off or in a mode that would not allow effective alert message presentation to a user.

In one preferred embodiment of the EAED, the GPS function is on a single chip, the satellite receiver function is on another chip, and the primary EAED firmware is on a third chip. These chips could be fabricated as part of a single package, but are described as separate chips to emphasize their distinct operations. The GPS chip can power on periodically or remain always on, depending on the power supply of the host device. The conserve power consumption, the GPS chip can operate only periodically. The satellite receiver chip is a low-power chip that is always on. It receives messages on the specific satellite frequency used by the EAS. The receiver chip checks message parts and reassembles messages sent in pieces. When a full, authentic message has been received, the satellite receiver sends this message to the firmware chip. This triggers the firmware chip to power on. By keeping the firmware chip dormant until a full, authentic message has been received, the power consumption is reduced. The firmware chip then performs most of the steps identified in either FIG. 6 or FIG. 7, as described above.

The EAED can use GPS data to determine the speed and elevation of a moving host device. In addition, the EAED can include an accelerometer, gyroscope, or other means to determine and monitor motion. These devices can be used by the EAED to determine if a crash has occurred, for example, when movement above a certain speed (e.g., 20 mph) has suddenly stopped or by detecting a stopping g force in excess of some preset limit. Whatever means is used, if an EAED within a smart device detects a crash, the EAED can then send crash and location information to emergency service providers; the police; contacts stored by the host device, or third-party monitoring services. This information can be sent by cellular transmission (3G, 4G, SMS, MMS, or other later-developed means), the Internet, Wi-Fi, or any other means available to the host device.

The accelerometer, gyroscope, or other motion detection means also could be used for personal safety reasons. It could be used, for example, to identify when a user has fallen. This feature could be used with at-risk users to automatically contact appropriate persons when the user has fallen. The capabilities might also allow the EAED to disable certain features when the host device is moving at a speed indicative of car travel.

The EAED can also interact with a smart host in other ways to enable remote monitoring of a user's actions. The EAED can receive a signal, via any means (e.g., cellular, Internet, satellite, etc.), to initiate monitoring of the location and movements of the device. The EAED can also be instructed to photograph or video using the host device's capabilities. This type of monitoring might be used by parents or by law enforcement under appropriate circumstances. For example, this capability by the EAED might allow parents to monitor their children's driving practices.

The EAED's integrated back-end use of location data could be used for commercially targeted messages, too. This practice could be used to notify users who fit a certain demographic profile when they are within a certain distance of a store or other facility. For example, a person within the target demographic group for a store having a sale might use this technology to notify such persons who are within a selected distance of the store. Though geographically-targeted advertising has been done, it has relied primarily on front-end message discrimination. The present invention takes advantage of real-time location information and the ability to perform the discrimination steps within the host device. This provides more accurate and thus, more finely-targeted messaging. Such messaging could be used for emergencies (as is the primary purpose of developing the system), civil announcements (e.g., a parents' meeting at a local school), instructional messages (e.g., road closures, power outages, etc.), educational messages (e.g., school closure), and/or commercial messaging as described in this paragraph. These and other uses of the system are possible because of the EAED's ability to receive messages with geographic or other targeting information such as medical information, corporate information and so forth, then determine, at the host device level, whether those requirements are met.

The foregoing examples of applications of the present invention are by no means exhaustive. It is expected that the EAED 20 of the present invention will be embedded in a wide variety of electronic products. The particular manner in which the EAED 20 is integrated with such products is left to the manufacturers and designs of the products. The present invention provides the EAED technology and an EAS method of operation. The manner in which EAEDs 20 are integrated into host systems is expected to vary a great deal.

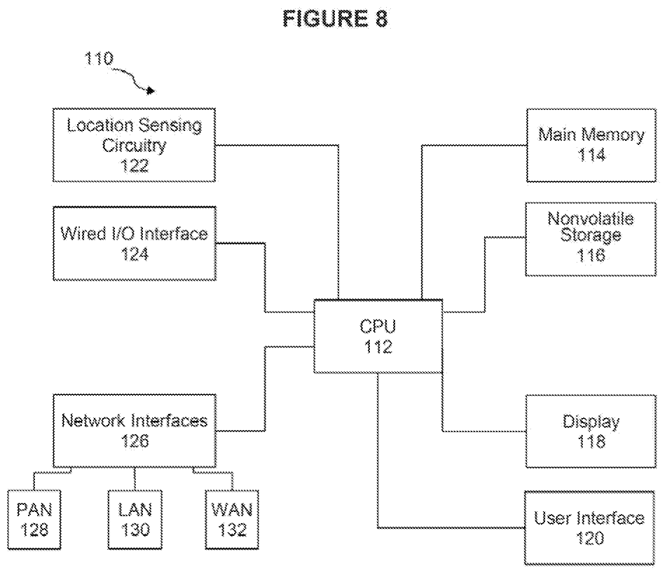

Although the present invention can use a standalone an EAED or EAED embedded in a host device in some embodiments, it is not limited to such use. Other devices can also be used including an electronic device 110 configured for alerting a user. FIG. 8 depicts a block diagram of the electronic device 110 that can be used with aspects of the present invention. It should be appreciated that embodiments of the electronic device 110 can include more or fewer elements than those shown in FIG. 8. The electronic device 110 can be, among other things, a handheld device, computer, smart television, wearable device such as a watch or glasses, and so forth. Examples of the electronic device 110 include, but are not limited to, an iPhone®, iPad®, iPod®, iMac®, or MacBook®, available from Apple Inc., or similar devices by any other manufacturer such as Android™ enabled devices.

As shown in FIG. 8, the electronic device 110 can include at least one central processing unit (CPU) 112. The CPU 112 can include one or more microprocessors. The CPU 112 can provide processing capability to execute an operating system, run various applications, and/or provide processing for one or more of the emergency alert methods described herein. Typical applications that can run on the electronic device 110 include a music player, a video player, a picture displayer, a calendar, an address book, an email client, a telephone dialer, and so forth. In addition, software for alerting a user of an emergency can be included on the electronic device 110.

A main memory 114 can be communicably coupled to the CPU 112. The main memory 114 can store data and executable code. The main memory 114 can represent volatile memory such as RAM, but can also include nonvolatile memory, such as read-only memory (ROM) or flash memory. The electronic device 110 can also include nonvolatile storage 116. The nonvolatile storage 116 can represent any suitable nonvolatile storage medium, such as a hard disk drive or nonvolatile memory, such as flash memory. The nonvolatile storage 116 is well suited for long-term storage, so it can store data files such as media (e.g., music files, video files, pictures, etc.), software (e.g., for implementing functions on the electronic device), wireless connection information (e.g., wireless network names and/or passwords, cellular network connections, etc.), and personal information (e.g., contacts, calendars, email, etc.). Additionally, data and/or code related to alerting a user of an emergency can be saved in the nonvolatile storage 116.

In some embodiments, a display 118 of the electronic device 110 can display images and/or data. The display 118 can be any suitable display, such as a liquid crystal display (LCD), a plasma display, an electronic paper display (e.g., e-ink), a light emitting diode (LED) display, an organic light emitting diode (OLED) display, a cathode ray tube (CRT) display, or an analog or digital television. In some embodiments, the display 118 can include touch screen or multi-touch screen technology that permits a user to interface with the electronic device 110.

The electronic device 110 can also include a user interface 120. The user interface 120 can include indicator lights, user inputs, and/or a graphical user interface (GUI) on the display 118. In operation, the user interface 120 can operate using the CPU 112, using memory from the main memory 114 and long-term storage in the nonvolatile storage 116. In an embodiment lacking the display 118, indicator lights, sound devices, buttons, and other various input/output (I/O) devices can allow a user to interface with the electronic device 110. In an embodiment having a GUI, the user interface 120 can permit interaction with interface elements on the display 118 with user input structures, user input peripherals (e.g. keyboard and/or mouse, etc.), or a touch sensitive implementation of the display 118.

The electronic device 110 can have one or more applications open and accessible to a user via the user interface 120 and/or displayed on the display 118. The applications can run on the CPU 112 in conjunction with the main memory 114, the nonvolatile storage 116, the display 118, and/or the user interface 120. Various data can be associated with each open application. As will be discussed in greater detail below, instructions stored in the main memory 114, the nonvolatile storage 116, or the CPU 112 of the electronic device 110 can alert a user of an emergency. It should be appreciated that the instructions for carrying out such methods can represent a standalone application, a function of the operating system of the electronic device 110, or a function of the hardware of the CPU 112, the main memory 114, the nonvolatile storage 116, or other hardware of the electronic device 110.

In some embodiments, the electronic device 110 can also have location sensing circuitry 122. The location sensing circuitry 122 can be global positioning system (GPS) circuitry, but can also represent one or more algorithms and databases, stored in the nonvolatile storage 116 or main memory 114 and executed by the CPU 112, which can be used to deduce location based on various observed factors. For example, the location sensing circuitry 122 can include an algorithm and database used to approximate geographic location based on the detection of local wireless networks (e.g., 802.11x, also known as Wi-Fi) or nearby cellular phone towers. As discussed above, the electronic device 110 can employ the location sensing circuitry 122 as a factor for alerting a user of an emergency. For example, the location sensing circuitry 122 can be used by the electronic device 110 to determine a user's location during an emergency event. The location during the event can then affect and/or determine the information displayed on the electronic device 110.

With continued reference to FIG. 8, the electronic device 110 can also include a wired input/output (I/O) interface 124 for a wired connection between one electronic device 110 and another electronic device 110. The wired I/O interface 124 can be, for example, a universal serial bus (USB) port or an IEEE 1394 port, but can also represent a proprietary connection. In addition, the wired I/O interface 124 can permit a connection to peripheral user interface devices, such as a keyboard or a mouse.

One or more network interfaces 126 can provide additional connectivity for the electronic device 110. The network interfaces 126 can include one or more network interface cards (NIC) or a network controller. In some embodiments, the network interface 126 can include a personal area network (PAN) interface 128. The PAN interface 128 can provide capabilities to network with, for example, a Bluetooth® network, an IEEE 802.15.4 (e.g., ZigBee) network, or an ultra-wideband (UWB) network. It should be appreciated that the networks accessed by the PAN interface 128 may, but do not necessarily, represent low power, low bandwidth, or close range Wireless connections. The PAN interface 128 can permit one electronic device 110 to connect to another local electronic device 110 via an ad-hoc or peer-to-peer connection. However, the connection can be disrupted if the separation between the two electronic devices 110 exceeds the range of the PAN interface 128.

The network interface 126 can also include a local area network (LAN) interface 130. The LAN interface 130 can be an interface to a wired Ethernet-based network or an interface to a wireless LAN, such as a Wi-Fi network. The range of the LAN interface 130 can generally exceed the range available via the PAN interface 128. In addition, in many cases, a connection between two electronic devices 110 via the LAN interface 130 can involve communication through a network router or other intermediary device.

In addition, for some embodiments of the electronic device 110, the network interface 126 can include the capability to connect directly to a wide area network (WAN) via a WAN interface 132. The WAN interface 132 can permit a connection to a cellular data network, such as the Enhanced Data rates for GSM Evolution (EDGE) network, a 3G network, a 4G network, or another cellular network. When connected via the WAN interface 132, the electronic device 110 can remain connected to the Internet and, in some embodiments, to another electronic device 110, despite changes in location that might otherwise disrupt connectivity via the PAN interface 128 or the LAN interface 130. As will be discussed below, the Wired I/O interface 24 and the network interfaces 126 can represent high-bandwidth communication channels for transferring user data using the simplified data transfer techniques discussed herein.

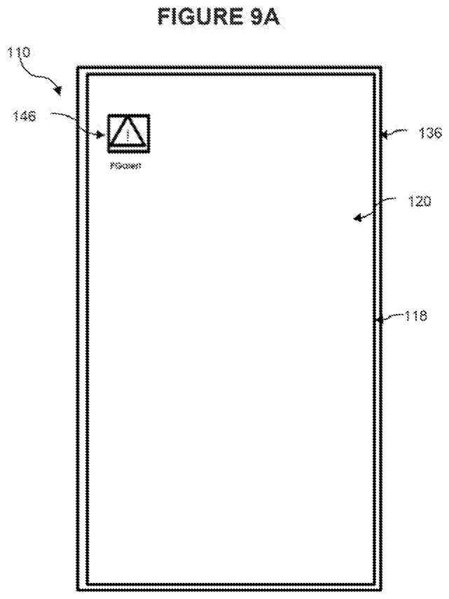

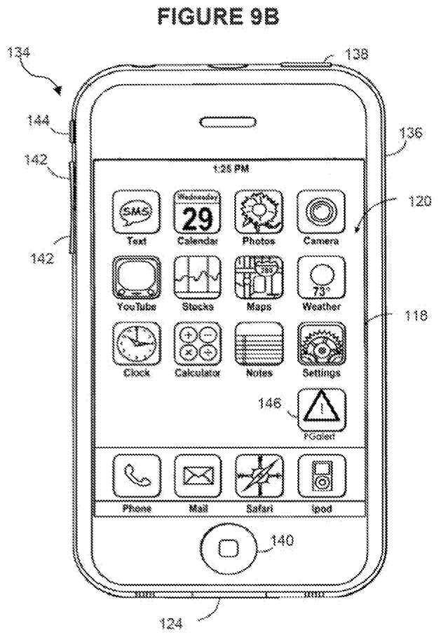

FIG. 9A illustrates an embodiment of the electronic device of FIG. 8 in accordance with aspects of the present invention. In this embodiment, the electronic device 110 can be handheld device 134 such as a portable phone and/or portable media player such as an iPhone®, iPad®, or iPod® available from Apple, Inc. The handheld device 134 can have an enclosure 136 constructed from plastic, metal, composite materials, or other suitable materials in any combination. The enclosure 136 can protect the interior components of the handheld device 134 from physical damage.

With continued reference to FIG. 9A, the electronic device 110 can include a user interface 120 in the form of a GUI. The user interface 120 on the display 118 can have one or more individual icons representing applications that can be activated. In certain embodiments, an emergency alert application can be selected by a user. For example, the display 118 can serve as a touch-sensitive input device, and the icons can be selected by touch. As shown in FIG. 9, the emergency alert application icon 146 can be designated as “PGalert” to indicate to a user that the selection of the icon 146 will allow the user to launch and use the emergency alert application. When the emergency alert application icon 146 is selected, the emergency alert application can open, and enable a user to use the emergency alert application. The handheld device 134 can also include user input structures that can supplement or replace the input capability of the display 118 for interaction with the user interface 120. FIG. 9B illustrates another embodiment of the electronic device of FIG. 8 as handheld device.

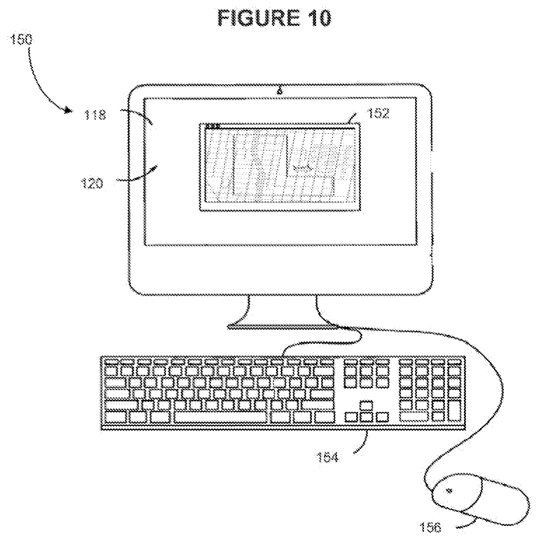

FIG. 10 illustrates an embodiment of the electronic device 110 of FIG. 8 in accordance with aspects of the present invention. In this embodiment, the electronic device 110 can be a computer 150. The computer 150 can be any computer such as desktop computer, server, notebook computer desktop or laptop. For example, the computer 150 can be a PC, iMac®, or MacBook®, etc. The computer 150 can have a user interface 120 that can be displayed on the display 118 of the computer 150 in the form of a GUI. The user interface 120 can show, for example, user interfaces for application 152 running on the computer 150. A user can interact with the user interface 120 via various peripheral input devices such as a keyboard 154 and/or mouse 156.

As discussed above, one or more electronic devices 110 can be configured to alert a user of an emergency. The electronic device 110 can be used to alert a user of an emergency as discussed above in relation to FIG. 4 at 42, 44, 46, 48, 50, and 52. However, instead of using a satellite 14 for transmitting the emergency alert message and geographic area message, a cellular network or Internet can be used as an alternative transmission options. The messages can be delivered using a series of broadcasts over the same and/or separate channels and then processed by the device as a single or multiple data packets.

For example, as discussed above in relation to FIG. 4 and also shown in FIG. 10, an emergency operator can use a front end application 152 that is a geographic mapping system that is on an electronic device 110 such as a computer 150 to define an alert area within which all persons must receive an alert message. The area defined to receive the alert can be stored in a geographic area message. The front end application 152 can be instructions stored in the main memory 114, the nonvolatile storage 116, or the CPU 112 of the computer 150 can alert a user of an emergency. Alternatively, the front end application 152 can be accessed from one or more servers via the Internet on a website using the computer 150. The front end application 152 can permit the emergency operator to specify the alert area using circles (indicating the radius in miles), squares, rectangles, or multi-sided polygons. The selected area can be lighted with a transparent layer having a color such as red, yellow, and so forth. Alternatively, the front end application 152 can allow the emergency operator to specify an entire jurisdiction.

The front end application 152 can include a secure login feature that limits access only to an authorized emergency operator. This can prevent unauthorized access to the front end application 152. Additionally, the front end application 152 can further limit access by restricting the geographic area operators can target for alert messages. For example, an emergency operator for the city police can send an alert message only to those people within the geographic area encompassed by the city limits, whereas an emergency operator for the state police can send an alert message to persons located anywhere within in the state including the city. This front end application 152 could use electronic street maps, satellite images, or combined satellite images overlaid with street map information. A suitable example of an electronic map includes a customized version of Google® maps.

The front end application 152 can also allow the emergency operator to select, create, and/or record an emergency alert message. The front end application 152 can assign a unique identifier to the emergency alert message and/or geographic area message. The front end application 152 can also allow the emergency operator to send the emergency alert message and geographic area message. The emergency alert message and geographic area message can be transmitted to other electronic devices 110 via the cellular system or Internet.

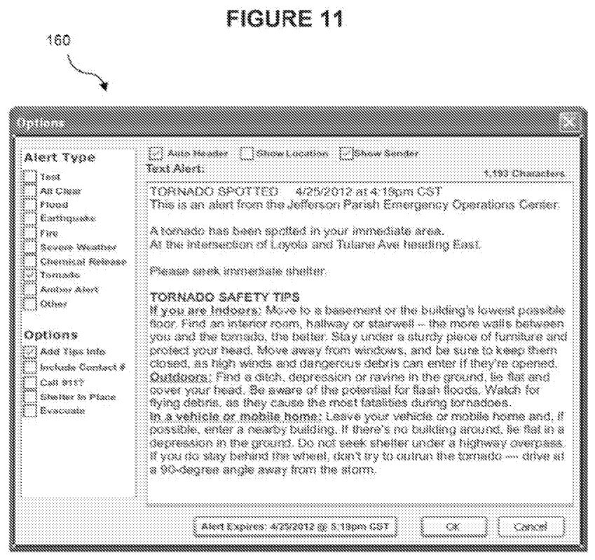

An exemplary emergency alert message created by an emergency operator shown in FIG. 11 at 160. As FIG. 11 illustrates, the front end application can permit the emergency operator to create an emergency alert message can include a variety of information such as time, date, location, emergency operations center identification, emergency tips, emergency type, and so forth. The emergency alert message can also include web enabled links and/or telephone numbers that are directed to additional sources with further information.

One or more electronic devices 110 can also be configured to receive a transmitted emergency alert message and geographic area message. The electronic device 110 can be used to alert a user of an emergency as discussed above in relation and EAED in FIG. 4 at 54, 56, 58, 60, 62, 64, and 66. Again, instead of using a satellite system, the electronic device 110 can receive the emergency alert message and geographic area message via a cellular network or Internet.

As shown in FIGS. 9A, 9B, 12A, 12B, 13A and 13B, the electronic device 110 can be a handheld device 134 having a device application 146 configured to notify a user of an emergency. Once the handheld device 134 receives the emergency alert message and geographic alert message area, the device application 146 can authenticate the geographic area message and/or emergency alert message. The device application 146 can also determine whether the handheld device 134 is located within a geographic area of concern using location data from the handheld device 134, which can be obtained from location sensing circuitry 122. The device application 146 can also authenticate the geographic area message and/or emergency alert message.

The device application 146 can present the emergency alert message on the handheld device 134 if the handheld device 134 is located within the geographic area of concern. The device application 146 can alert the user in several manners (e.g. playing a unique and/or specified alert warning tone, vibrating using a unique and/or specified alert warning tone, displaying a banner indicating an alert message has arrives, and so forth.) The device application can repeatedly alert the user over a specified time period (e.g. every 15 seconds, 30 seconds, 1 minute, 10 minutes, etc.).

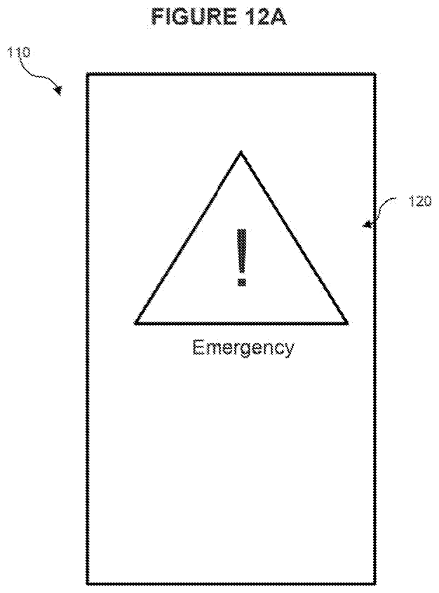

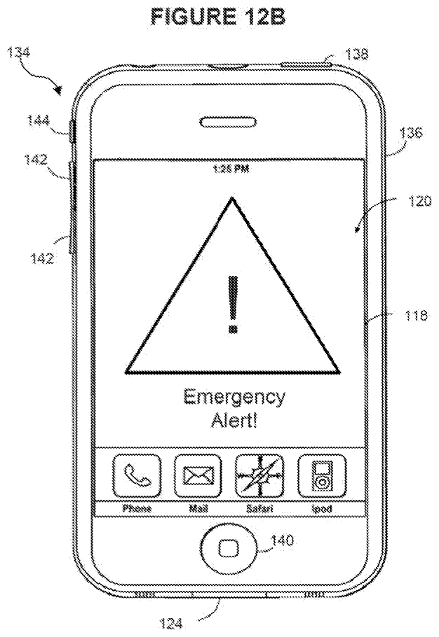

An exemplary emergency alert that can be presented by the device application 146 on the electronic device 110 is shown in FIG. 12A. An exemplary emergency alert that can be presented by the device application 146 on a handheld device 134 is shown in FIG. 12B.

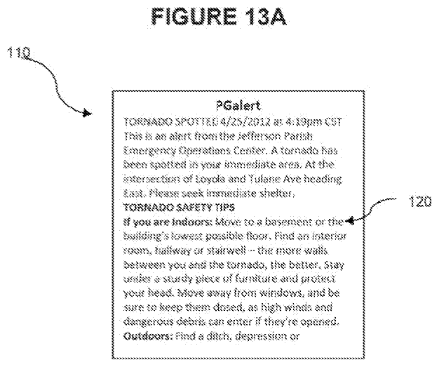

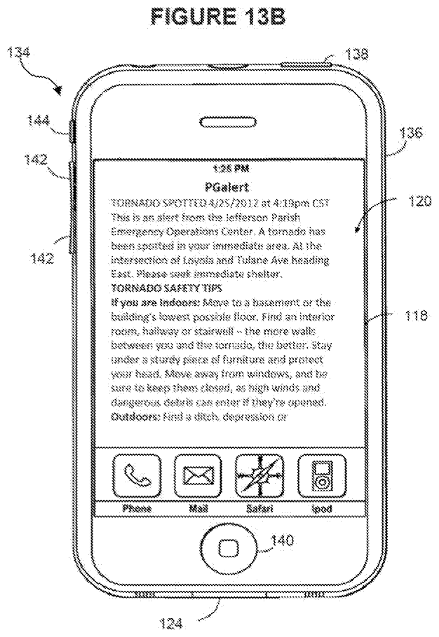

FIG. 13A depicts an exemplary emergency alert message that can be presented by the device application 146 on the electronic device 110. FIG. 13B depicts an exemplary emergency alert message that can be presented by the device application 146 on a handheld device 134.

As shown in FIG. 13A and FIG. 13B, the emergency alert message can contain a variety of information such as emergency type, emergency location, emergency operations center identification, emergency tips, and so forth.

The device application 146 can also allow the user to view current and previous alerts at any time. In addition, the device application can allow the user to add one or more fixed geographic locations that can be distinct from the location of the handheld device 134. This can allow the user to receive alerts in many locations. For example, if the user is traveling out of town, they could still receive alerts at their home address as well as the location of where they are traveling (i.e. the location of the handheld device 134). The device application 146 can also be configured to allow the user to directly contact emergency authorities (police, fire, EMS, 911, etc.) without having to enter in the contact information. The device application 146 would already have this information. The user could select a “quick dial” option that would dial a selected emergency authority. The device application 146 can also be configured to alert others (e.g. family members, friends, etc.) in the same manner as an emergency authority. The device application 146 can also be figured to have links to major and local news outlets based on the current location of the handheld device 134.

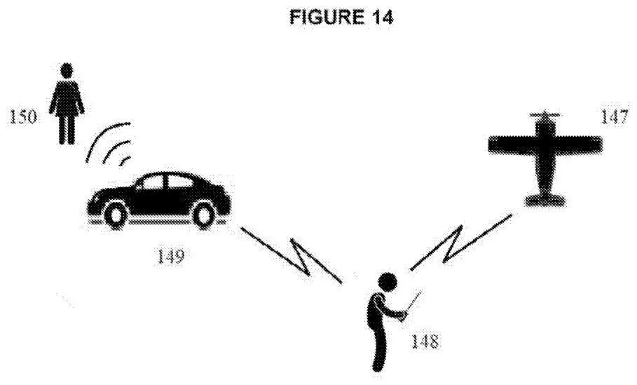

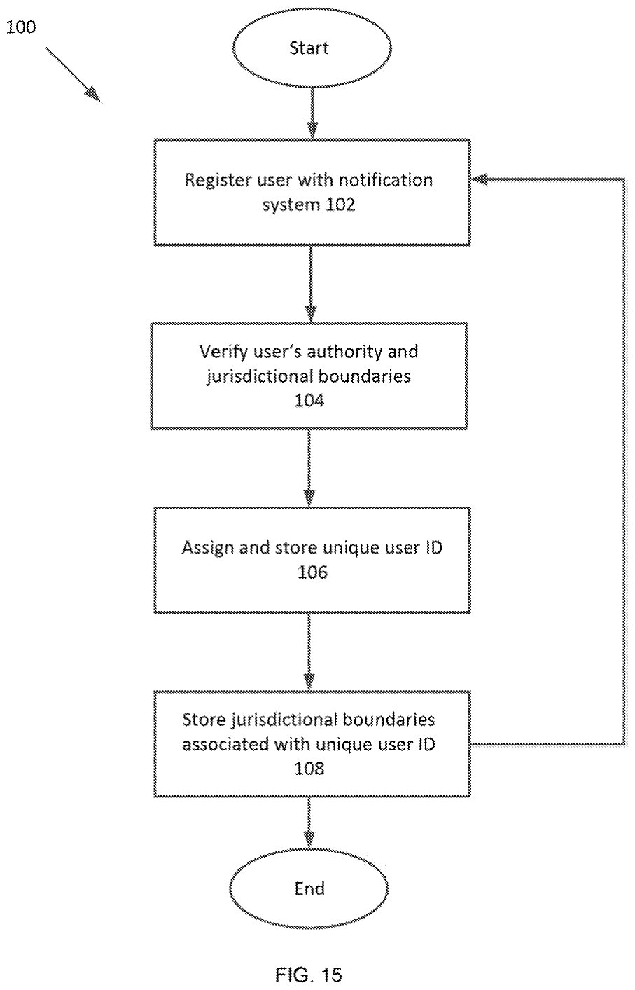

FIG. 15 is a flowchart that illustrates a set up process 100 for registering operators with the alert notification system an operator is registered with the alert notification system at 102. For example, the operator can utilize a client device to register with the notification system. In one embodiment, the operator is a message originator client and has authority related to a geographical jurisdiction. In this embodiment, the operator can be register to gain access to the alert notification system for a specified geographical jurisdiction. In one embodiment, the operator can be registered with a proprietor, to acquire access to the mass notification network. The registration process is designed to verify that the registering entity has jurisdiction over the geographic area they are applying to send notifications. Credentials can include verifying ownership or valid lease of the geographic footprint or verifying geographic boundaries of responsibility and authority for public safety. Operator name should match legal name on public records confirming jurisdiction. The process can include verifying registration of geographic area with public records and/or public authorities.

At 104, the authority and jurisdictional boundaries of the operator are verified. In one embodiment, the validity of the operator's authority and jurisdictional boundaries are verified with proper authorities. This can be done either by electronic verification with local or state records such as property tax records or legal title documents or by verifying with government authorities responsible for authorizing public entities jurisdictional boundaries. In one embodiment, a request to verify the credentials of an operator is forwarded to a server of the proper authority with the credentials of the operator and the verification is performed by the proper authority.

A unique identifier (ID) can be assigned to an operator and stored, at 106. For example, the unique ID can be a symbol, code or number that can be used to uniquely identify the operator or client. In one embodiment, the unique ID is assigned to an operator and stored in a database if the operator is verified at 104. In one embodiment, the database is a proprietary server database, such as a database owned and maintained by Advanced Computer & Communications, LLC or a related business entity.

In one embodiment, in addition to unique IDs, transaction authorization numbers (TANS) can be issued when an operator has qualified to be entered into the database as an authorized user of the system. A transaction authorization number (TAN) can be entered when creating a message for delivery to allow access to the notification system. A TAN can be valid for only one message delivery and each message sent by a qualified user will have a unique TAN.

Finally, the jurisdictional boundaries associated with a unique operator ID are stored, at 108. In one embodiment, one jurisdictional boundary can be associated with a unique operator ID. In another embodiment, multiple jurisdictional boundaries can be associated with a unique operator ID. For example, one or more jurisdictional boundaries can be associated with each unique operator ID and stored in database.

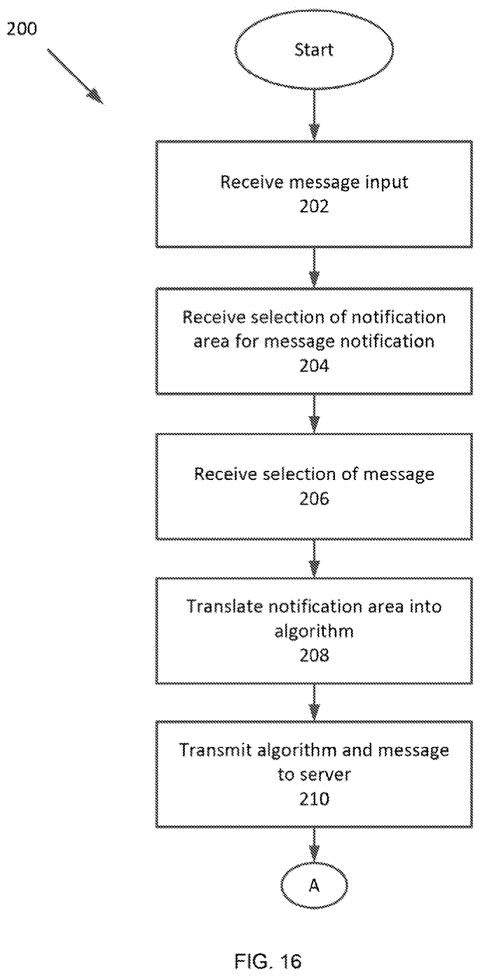

The process for sending a mass alert message utilizing the issue alert notification system will now be explained in more detail. FIG. 16 illustrates one embodiment of a flow chart 200 for processing a message from an operator of the notification system.

To start the process, message input from an operator is received, at 202. In one embodiment, a qualified operator can create a message utilizing the client device. In one embodiment, a TAN can entered at the client device when creating the message to allow access to the notification system. In one embodiment, the client device includes application software for receiving and processing the input message from the operator. The application software can include message originator software that is certified and approved to receive the message input from the operator and interface with notification server that examines, processes, and validates the message before sending the message to intended customers or clients.

At 204, selection of a notification area for message notification is received. In one embodiment, the application software receives the selection of an area on a map where the message is to be broadcasted to customers or end operators. In one embodiment, the geographic area where an alert message is to be broadcasted to customers or end operators is selected by a qualified operator on a map provided by the application software on a touch screen display of the client device. In another embodiment, the operator can input a geographic code or other description of a geographic area where the message is to be transmitted to end users or customers.

The message is then selected, recorded, and/or entered, at 206. The operator can select a message from among a selection of messages the operator inputs into the system or the operator can create a new custom message. A mapping can be generated by client software between the message created at step 202 and default messages stored on the server or pre-stored messages by operator. The operator can use pre-defined message areas (i.e. a river bottom for a flash flood warning, or a neighborhood/district) or the operator can draw a new message area. When the message is “selected,” an operator either enters a new message into the alert origination software or selects from existing messages already created. When the messages are “recorded,” the operator confirms that the message is correct as intended and the target area for the message is correct. When the message is “entered,” this is performed by an operator or is it performed automatically by the client software. In one embodiment, a message can be the result of machine to machine communication, for example, a gas detection system or a flood detection system sending the data directly to an alert generation portal that then automatically sends a message to geographic coordinates provided by the detection system.

Next, the notification area is translated into an algorithm, at 208. In one embodiment, the notification area of the map is translated into a mathematical algorithm. In one embodiment, the notification area is translated at the client device. At 210, the algorithm and the message are transmitted to notification server. For example, the message provided at 202 and the algorithm generated at 208 are sent by client device to notification server.

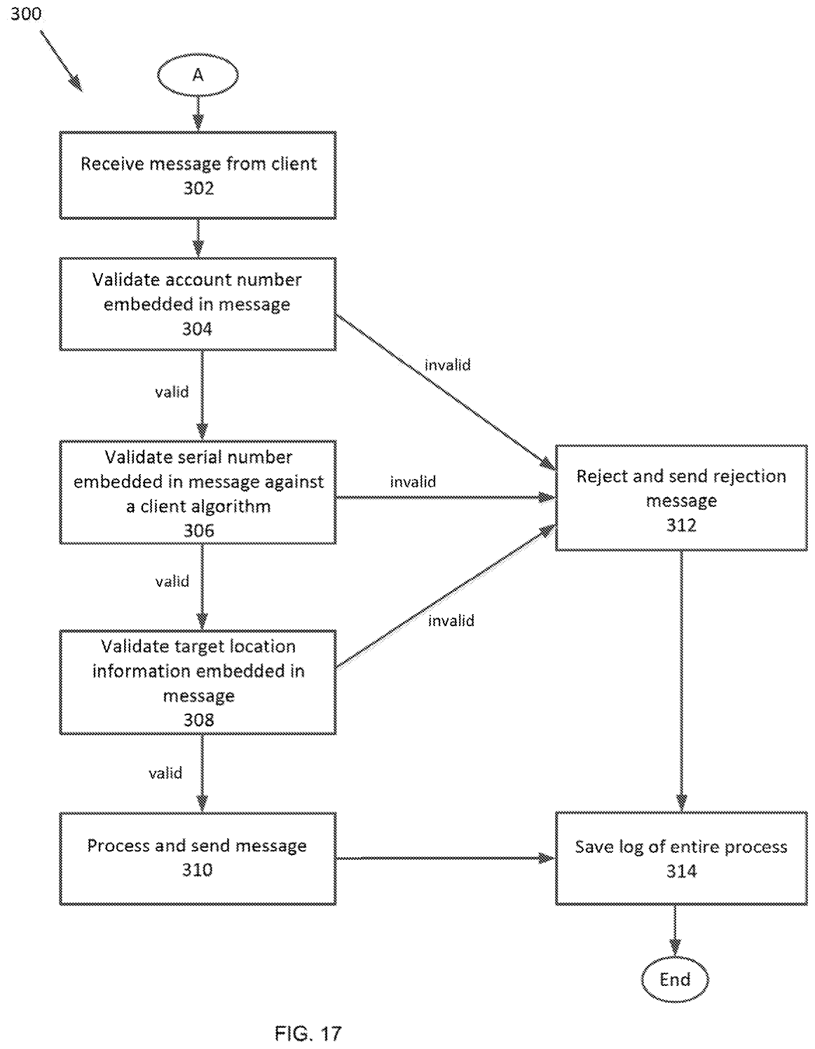

FIG. 17 is a flow chart that illustrates an exemplary process 300 for validating and transmitting an alert message by notification system. At 302, a notification server receives a message from the client. For example, the notification server receives the alert notification message sent from client device at 210. In one embodiment, the notification server can be a message aggregator server for aggregating and validating messages from one or more qualified operators. In one embodiment, the message can contain embedded information such as an account number, a serial number, and message target location information. The message target location information can include a location associated with target customers intended to receive the message. The serial number identifies a unique message. The account number identifies a unique client and/or a unique operator. The message target area is the targeted area within the client's jurisdiction for that message. These numbers can be associated with a client or qualified operator of the system. Some clients can want to allow different levels of authority to different operators. In that case, both a client number and an operator number would be needed for verification. In one embodiment, notification server verifies that an account number embedded in the message is stored in a server database and associated with a qualified operator.

The account number embedded in the message can be validated, at 304. In one embodiment, notification server verifies that an account number embedded in the message is stored in a server database and associated with a qualified operator. For example, the account number is compared to account numbers stored in server database, to determine if the account number is associated with a qualified operator. In one embodiment, if the account number is not validated at 304, the message is rejected and a rejection message is generated at 312. In one embodiment, the rejection message can be sent to client device at 312.

The serial number embedded in the message can be validated, at 306. In one embodiment, the embedded serial number is validated against a specific client algorithm stored at the server database. This step can utilize the algorithm generated at step 208. For example, the geographic coordinates of the message area can be compared to the geographic coordinates of the clients jurisdiction stored in a database to verify that the message area is within jurisdictional boundaries. In one embodiment, if the serial number is not validated at 306, the message is rejected and a rejection message is generated at 312. In one embodiment, the generated rejection message can be sent to the client device.

The target location information embedded in the message can be validated, at 308. In one embodiment, the embedded target location information is compared to location information stored in the server database. In one embodiment, one or more specific locations stored in the server database can be associated with a specific qualified operator of the notification system. For example qualified operator A can be allowed to transmit alert notifications to locations A, B, and C. In one embodiment, if any part of the embedded target location is determined to be outside of the message area allowed for the operator as stored in the server database ###, the message can be deemed invalid. If the target location information is not validated at 308, the message is rejected and a rejection message is generated at 312. In one embodiment, the rejection message can be sent to the client device. The message area must be within the jurisdictional boundaries. The authorization and authentication process ensures that an authorized message is selectively and uniquely delivered within the jurisdictional boundaries.

In one embodiment, the notification system can employ an additional verification method. When an alert is received by a notification server from a qualified message originator client via the Internet or through another communication means, an authorization code is generated and sent to the message originator, using a different means of communication than the one originally used to send the message. For example, if a client device A of the operator is used to send an alert message to the notification server, an authorization code can be generated by a notification system and sent to a client device B of the user. The authorization code can be entered into the client device A and used to verify the operator, i.e. to verify the originator of the message. In another embodiment, the authorization code can be entered into client device B and used to verify the operator.

The notification server can process and send the message to targeted customers or end operators, at 310. In one embodiment, the message is sent to targeted customers if the account number, the serial number, and the target location information embedded in the message are all determined to be valid. Finally, a log of the entire process can be saved, at 314.

Public safety agencies typically pay venders, such as software vendors, for systems that send geo-fenced non-wireless emergency alerts—regarding for example boiling water, weather advisories, traffic notices, and other public notifications—to communities. These are usually opt-in database systems that employ apps. Typically only about 3-5% of a given community downloads the app and registers. Not only are such systems limited in the number of people they reach, but they are not transferable from community to community. Further, if the public safety agency wants to change venders, the new vendor often has to rebuild the database. Present embodiments address those limitations and can provide significant opportunities to leverage a device-based cell broadcast system to create a wireless industry partnership. In particular, a mass notification network (MNN) can be implemented with a paid-access service to all devices. Present embodiments can provide public safety agencies an interoperable system to geographically fence all alerts, both wireless emergency alert (WEA) systems and non-WEA systems. The MNN can reach nearly all people in a given community, regardless of where individuals that are physically within the community at a given time are actually from in the country or the world. The MNN can also be implemented as a partnership with participating wireless carriers, PGAlert, and others.

A role within the MNN can be a clearinghouse for alert and/or message origination service providers to gain access to all participating wireless industry mobile devices. Capabilities of the MNN should be attractive to public and private entities and associations of all shapes and sizes. The MNN and clearinghouse can be both secure and scalable.

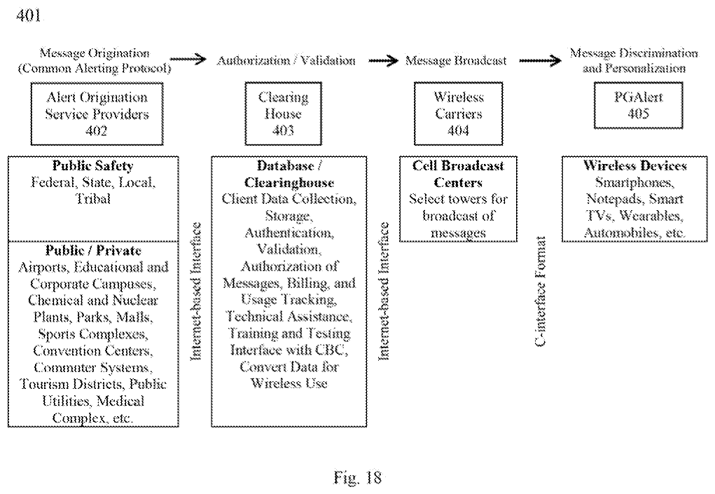

FIG. 18 provides an overview of an MNN ecosystem 401. Message origination can be based on the Common Alerting Protocol (CAP), an international standard that is used by FMEA and IPAWS to send public alerts and warnings, or based on other protocols of alert origination service providers 402. The alert originators can include public safety agencies, whether federal, state, local, or tribal. The MNN can also be implemented for semi-public and private organizations, such as airports, educational and/or corporate campuses, chemical and/or nuclear plants, parks, malls, sports arenas and complexes, convention centers, commuter systems, tourism districts, museums, galleries, fair grounds, concert halls, public utilities, medical complexes, or any area in which people are found. The MNN can be responsible for authorization and/or validation though the clearinghouse 403. The clearinghouse can include a database and can be responsible for client data collection, data and information storage, user and client authentication, validation, authorization of messaging, billing, usage tracking, technical assistance, data conversion, such as converting data from one protocol into a format for another protocol, as well as training and testing with, e.g., CBC. Message broadcasting can be addressed by the MNN through wireless carriers 404 or carrier infrastructure and/or interfaces. In particular, the MNN can include one or more cell broadcast centers that can select towers for broadcasting of messages. Further, message discrimination and/or personalization can be handled by PGAlert 405, which can communicate directly with wireless devices, such as smartphones, notepads, smart TVs, wearables, automobiles, and other devices having network and/or wireless capabilities.

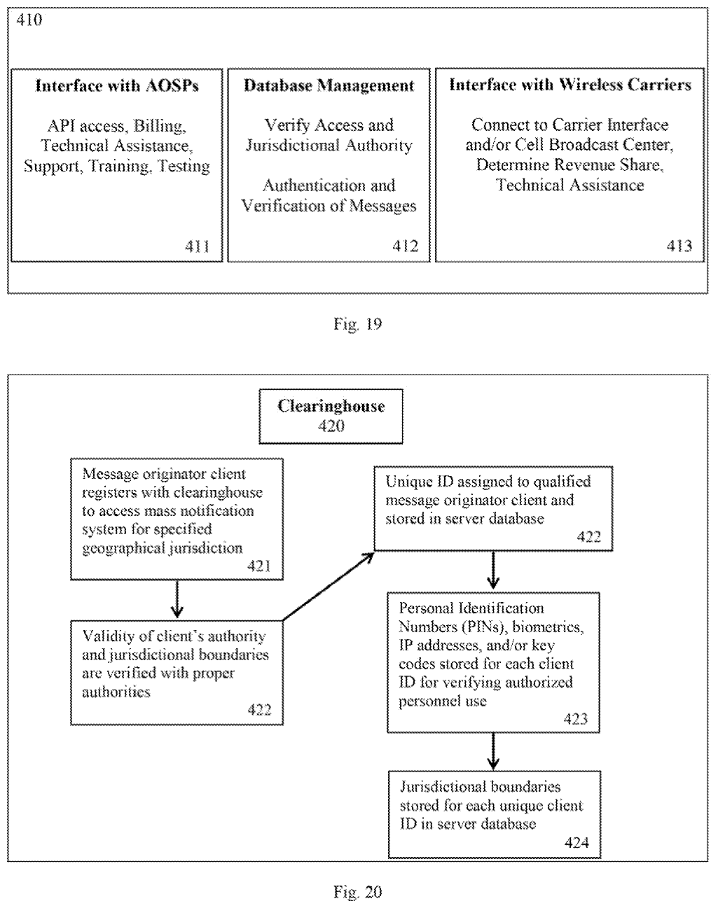

FIG. 19 is a diagram separating key functionalities of a clearinghouse 410 according to an exemplary embodiment. For example, the clearinghouse includes an interface for alert origination software providers (AOSPs) 411. The interface can be based on application-program interface (API) access to achieve a universal system that can work across vendor platforms. The interface can be designed to provide billing information, technical assistance, support, training, and testing, as well as other useful information. The clearinghouse can include a database management system 412, which can be utilized to verify access and jurisdictional authority for messaging, as well as can provide authentication and verification of specific messages from a message originator. The clearinghouse can further provide an interface 413 for wireless carriers. The interface can facilitate connections to carrier interfaces and/or the cell broadcast centers. The interface can also determine revenue sharing information and technical assistance.

An exemplary setup for a clearinghouse embodiment 420 is shown in FIG. 20. Message originator clients can register 421 with the clearinghouse to access a mass notification system for a specified geographical jurisdiction. The clearinghouse can determine the validity 422 of the registered client's authority to send messages, as well as verify the jurisdictional boundaries for such messages. A unique ID, as further discussed above, can be assigned 422 by the clearinghouse to a qualified message originator client and can store the unique ID in a server database. The clearinghouse can utilize 423 personal identification numbers (PINs), biometrics, IP addresses, key codes, and/or other identifying information to verify whether message originators are authorized personnel. Further, the clearinghouse can utilize 424 jurisdictional boundaries associated with each unique client ID from a server database for the message originators.

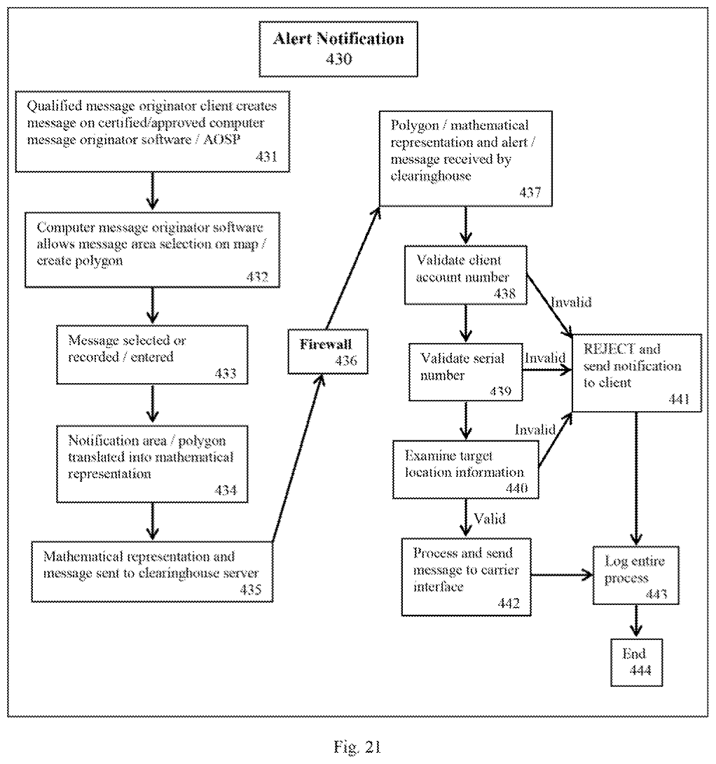

FIG. 21 illustrates an exemplary flow diagram for alert notifications 430 that are sent through the mass notification network. As shown, a qualified message originator client, such as an AOSP, can create a message 431 using a pre-certified or pre-approved computer message originator software program. Alternatively, as discussed above, some preferred embodiments of the MNN can utilize APIs, which can allow the AOSP to use any software program to originate the message. Accordingly, for MNNs utilizing APIs, or other interfaces, other validation or approval mechanisms discussed here can be utilized.

The computer message originator software can select 432 notification areas on a map for sending the message, and the area can be simplified to a polygon. Alternatively, for API embodiments, the selection of map areas can be made by the clearinghouse. The message can be selected from a list of messages 433 or custom messages can be created by the AOSP. The notification area can be translated into mathematical representation 434. The mathematical representation and message can be sent 435 to the clearinghouse server.

A firewall 436 is shown and preferably located between the computer message originator software program and the clearinghouse. The firewall can utilize SSL certificates or can utilize other protocols for secure encrypted transmissions. In a preferred embodiment, transmissions from the client to the clearinghouse are encrypted, but such transmissions are not required to be encrypted and other communication methods are contemplated as well.

The polygon or mathematical representation and the alert or message can be received 437 by clearinghouse. The clearinghouse can then perform a three-step process regarding the originated message. First, the clearinghouse can validate the client's account number 438. The software program can be responsible for embedding the account number in the message. The clearinghouse retrieve client account numbers from its server database and can compare the account number embedded in the message against the appropriate number stored in the server database. Second, the clearing house can validate a serial number 439 embedded in the message by the software program against specific client authorities and jurisdictional reach, which can also be stored in the server database. Third, the clearinghouse can examine the message's target location information 440, which can also be embedded in message. The clearinghouse can compare the target location information to the client's allowed locations that can be stored in the server database.

If the clearinghouse determines during any of the three steps that the originated message is invalid 441, then the message can be rejected and an appropriate notification message can be sent to the client. If on the other hand the message passes all three steps and the clearinghouse determines the message to be valid, then the message can be processed and sent 442 to the carrier interface, and ultimately to alert-enabled devices in the targeted area. In either case—i.e. a message is determined to be invalid or valid—the clearinghouse saves a log 443 of the entire process before ending 444 the alert notification process.

The invention can be utilized by various industries beyond the traditional alert notification industry. For example, embodiments can be implemented advantageously for healthcare providers. In particular, the one-way broadcast functionality can be used to send diagnostic questions along with a message. An alert-enabled device can analyze the diagnostic questions and find information within the device to answer the questions. Such information can include health indicators that have been gathered by, e.g., wearables or other technologies attached to and/or contained on the device. After receiving the one-way broadcast and if the diagnosis results are positive, then the device can display the relevant message. On the other hand, if the results are negative, then the device can simply not render the message.

In an alternative embodiment, the system can utilize a graded-scale approach to diagnosis. For example, in addition to the message and the diagnostic questions, the system can send scoring or weighting functions associated with each of the diagnostic questions. By utilizing weighting functions, the alert-enabled device can answer less than all of the questions yet still obtain a result that will allow the message to be presented or be disregarded by the device. The system can also achieve a likelihood of a positive/negative result by utilizing weighting functions, rather than simply a positive/negative result.

This technology can enable healthcare providers, or even health officials such as those associated by agencies like the Center for Disease Control, to use a mass notification to send targeted messages to an at-risk population. The system is particularly useful for healthcare entities that do not have an existing personal or professional relationship with the message recipients. This is because the diagnosis of or risk to the individual can be determined using health information available on or to the device without extracting any of the information. The individuals can therefore be informed of a possible health issue without risking an invasion of the individuals' privacy.

Embodiments are also useful for machine-to-machine communication. For example, a one-way broadcast can be sent with diagnostic questions along with electronic execution commands. The diagnostic questions can find answers on a device or machine that can then determine if the electronic commands should be executed. Accordingly, a one-way transmission can be utilized for point to multipoint broadcasts to execute commands on a specific machine, machines that meet specific criteria, and/or machines in a specific area.

All of the systems, apparatus, and methods disclosed and claimed herein can be made and executed without undue experimentation in light of the present disclosure. In addition, from the foregoing it will be seen that this invention is one well adapted to attain all the ends and objects set forth above, together with other advantages. It will be understood that certain features and sub-combinations are of utility and can be employed without reference to other features and sub-combinations. This is contemplated and within the scope of the appended claims. All such similar substitutes and modifications apparent to those skilled in the art are deemed to be within the spirit and scope of the invention as defined by the appended claims.

Exemplary embodiments described, shown, and/or disclosed herein are not intended to limit the claims, but rather, are intended to instruct one of ordinary skill in the art as to various aspects of the invention. Other embodiments can be practiced and/or implemented without departing from the scope and spirit of the following claims.

1. An alert system, comprising:
a notification server that receives an emergency message from a client device, wherein the emergency message includes a primary emergency alert and a specification of a geographic area of concern, and wherein the notification server is configured to determine whether the emergency message is valid;
a transmission system configured to, upon validation of the emergency message, transmit the emergency message to an alert-enabled device;
wherein the alert-enabled device is configured to receive the emergency message, to determine if the alert-enabled device is within the geographic area of concern, and to present the emergency message to a user if and only if the alert-enabled device is located within the geographic area of concern.

2. The alert system of claim 1, further comprising: an operations center configured to select the primary emergency alert from a group of alerts, to specify the geographic area of concern, and to transmit the emergency message.

3. The alert system of claim 2, wherein the operations center is configured to create the primary emergency alert and wherein the specification is representative of a subpart of the geographic area of concern.

4. The alert system of claim 1, further comprising a plurality of channels configured to propagate a series of broadcasts.

5. The alert system of claim 4, wherein the operations center is further configured to transmit a commercial message to the alert-enabled device, and wherein the alert-enabled device is configured to receive the commercial message when the alert-enabled device is within a geographic area of interest.

6. The alert system of claim 4, wherein the series includes the emergency message.

7. The alert system of claim 5, wherein the emergency message is transmitted as a plurality of packets, and wherein alert-enabled device is further configured to process the plurality of packets to recover the emergency message.

8. The alert system of claim 1, wherein the alert-enabled device is configured to determine its geolocation and to store the geolocation.

9. The alert system of claim 8, wherein the alert-enabled device is configured to determine if the alert-enabled device is within the geographic area of concern based on a stored geolocation.

10. The alert system of claim 8, wherein the alert-enabled device is designed to analyze locational information and, based on the analyzed locational information, to determine if the alert-enabled device is within the geographic area of concern.

11. The alert system of claim 8, wherein the alert-enabled device is configured to obtain location information from another device in communicative proximity to the alert-enabled device.

12. The alert system of claim 1, wherein the alert-enabled device is embedded in a host device and configured to activate the host device upon receiving the emergency message and to deactivate the host device after presenting the primary emergency alert.

13. The alert system of claim 1, wherein the alert-enabled device is a GPS enabled cellular phone or a portable computer configured to receive wired or wireless signals.

14.-24. (canceled)

25. A method of targeting communications, comprising:
transmitting a message and a set of diagnostic queries;
receiving, by an alert-enabled device, the message and the set of diagnostic queries;
determining answers to the diagnostic queries based on information stored in the alert-enabled device; and
determining, based on the answers, whether to display the message on the alert-enabled device.

26. A mass notification network, comprising:
a clearinghouse having a database;
a first Internet-based interface to the clearinghouse for receiving origination messages;
a plurality of cell broadcast centers;
a second Internet-based interface between the clearinghouse and the plurality of cell broadcast centers; and
a cellular interface to the plurality of cell broadcast centers.

27. The mass notification network of claim 26, wherein the first Internet-based interface is configured according to the Common Alerting Protocol.

28. The mass notification network of claim 27, wherein the cell broadcast centers are configured to select cellular towers for broadcasting origination messages.

29. The mass notification network of claim 28, wherein the clearinghouse is configured to verify authorizations and jurisdictional boundaries associated with the origination messages.
